(19) United States
(12) Patent Application Publication
(10) Pub. No.: US 2015/0220114 A1
(43) Pub. Date: Aug. 6, 2015

(54) Devices, Systems and User Interfaces for Simplifying Control of Portable Computers

(71) Applicant: ABiSee, Inc., Acton, MA (US)

(72) Inventor: Leon Reznik, Sudbury, MA (US)

(21) Appl. No.: 14/616,123

(22) Filed: Feb. 6, 2015

Related U.S. Application Data
(60) Provisional application No. 61/936,695, filed on Feb. 6, 2014.
(60) Provisional application No. 62/008,909, filed on Jun. 6, 2014.
(60) Provisional application No. 62/059,279, filed on Oct. 3, 2014.

(51) Int. Cl. G06F 1/16

(52) U.S. Cl. CPC G06F 1/1633

(57) ABSTRACT

Devices, systems and user interfaces for simplifying control of portable computers are provided. For example, a system for simplifying operation of a computing device may comprise a frame defining a receptacle, the receptacle being sized and shaped to receive a computing device; one or more controllers disposed on the frame; and an electrical connector disposed in the receptacle for electrically connecting the frame to the computing device, wherein, when the frame is electrically connected to the computing device, the one or more controllers are enabled to operate the computing device.

### RELATED APPLICATIONS

This application claims the benefit of and priority to U.S. Provisional Application No. 61/936,695, filed on Feb. 6, 2014, U.S. Provisional Application No. 62/008,909, filed on Jun. 6, 2014, and U.S. Provisional Application No. 62/059,279, filed on Oct. 3, 2014. All of these applications are incorporated herein by reference in their entirety.

### FIELD

The present disclosure relates to cases for computing device to simplify the operation of a computing devices received in the case.

### BACKGROUND

The popularity of portable computing devices, such as tablets and smart phones, has been rapidly increasing. Most such devices are provided with user interface built around the devices' multi-touch screen, including a virtual keyboard. These virtual controllers allow the manufacturers to decrease the size of their devices, while keeping much functionality and applications of desktops and laptops. However, many users may have difficulty with virtual features of portable computing devices. Accordingly, there is still a need to simplify the use of portable computing devices with virtual control features.

### SUMMARY

According to some aspects of the present disclosure, there is provided a system for simplifying operation of a computing device comprising a frame defining a receptacle, the receptacle being sized and shaped to receive a computing device; one or more controllers disposed on the frame; and an electrical connector disposed in the receptacle for electrically connecting the frame to the computing device, wherein when the frame is electrically connected to the computing device, the one or more controllers are enabled to operate the computing device.

According to some aspects of the present disclosure, there is provided a system for simplifying operation of a computing device comprising a frame defining a receptacle, the receptacle being sized and shaped to receive a computing device; one or more controllers disposed on the frame; an electrical connector disposed in the receptacle for electrically connecting the frame to the computing device; and a simplified user interface to be run on the computing device, wherein when the frame is electrically connected to the computing device, the one or more controllers of the frame are enabled to operate the computing device through the simplified user interface.

According to some aspects of the present disclosure, there is provided a method for simplifying a control of a computing device, the method comprising inserting a computing device into a receptacle defined by a frame, the frame further comprising one or more controllers disposed on the frame and an electrical connector disposed in the receptacle for electrically connecting the frame to the computing device; connecting the computing device to the frame through the electrical connector to enable the one or more controllers are enabled to operate the computing device; and using the one or more controllers of the frame to operate the computing device.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1A is a prospective view of an embodiment of a tablet case of the present disclosure;

FIG. 1B and FIG. 1C is a prospective view of an embodiment of a tablet case of the present disclosure;

FIG. 2A illustrates a tablet computer partially inserted into a tablet case of the present disclosure;

FIGS. 2B and 2C illustrate a front view of a tablet computer fully inserted a tablet case of the present disclosure;

FIG. 2D illustrates an embodiment of a tablet case of the present disclosure;

FIG. 3A and FIG. 3B illustrate an embodiment of a lens adaptor system for use with a tablet case of the present disclosure;

FIG. 3C illustrates an embodiment of a lens adaptor system for use with a tablet case of the present disclosure;

FIG. 4A illustrates an embodiment of a tablet case of the present disclosure having imaging units that can be oriented relative to a target;

FIG. 4B illustrates an embodiment of a tablet case of the present disclosure having a down-facing imaging units with a lens and a sensor.

FIG. 5A, FIG. 5B, FIG. 5C and FIG. 5D illustrate an embodiment of a tablet case of the present disclosure having rotatable imaging units;

FIG. 6 illustrates an embodiment of a tablet case of the present disclosure having a telescoping imaging units;

FIG. 7A illustrates of an embodiment of a tablet case of the present disclosure;

FIG. 7B of an embodiment of a tablet case of the present disclosure;

FIGS. 8A, 8B and 8C illustrate a tablet case of the present disclosure having a foldable support.

FIGS. 9A, 9B and 9C illustrate an embodiment of a tablet case of the present disclosure that can be used with a smart phone.

FIG. 10 illustrates a simplified user interface (UI) layer of the present disclosure;

FIG. 11 illustrates an embodiment of a tablet case of the present disclosure with a simplified user interface;

FIG. 12 is a perspective view of a stand for a computing device, according to embodiments of the present disclosure;

FIG. 13 is a front view of a stand for a computing device, according to embodiments of the present disclosure;

FIG. 14 is a back perspective view of a stand for a computing device, according to embodiments of the present disclosure;

FIG. 15 illustrates an embodiment of a tablet case of the present disclosure with a reflective member;

FIG. 16 illustrates gears for rotating the reflective member of FIG. 15;

FIG. 17 presents an embodiment of a tablet case of the present disclosure with multiple additional lenses, according to embodiments of the present disclosure;

FIG. 18 presents an embodiment of a lens strip for holding additional lenses, according to embodiments of the present disclosure;

FIG. 19 and FIG. 20 are a cross sectional view of an exemplary mechanism for interchanging additional lenses, according to embodiments of the present disclosure;

FIG. 21 presents an embodiment of a stand for a computing device of the present disclosure when folded, according to embodiments of the present disclosure; and

FIGS. 22 and 23 illustrate the effect of a reflective member of the field of view of a camera of the present disclosure.

FIG. 24 illustrates an embodiment of a device of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

In some embodiments, the present disclosure provides a case for a portable computing device, such as a tablet computer or smart phone. Portable computers such as iPad, Android or Windows tablets and smartphones, as well as desktop PCs and laptops are hard to use by people with disabilities such as blindness, shaky hands, poor vision, etc., elderly people, and people who do not have much prior experience using portable computing devices, such as a tablet. This especially true for portable computers that rely on the touch screen and virtual controllers (such as a virtual keyboard), and often lack exterior or outward controllers. The present disclosure provides a tablet case for the portable computing device, such as tablet or smart phone, to simplify operation of the tablet. The tablet case may be constructed using a variety of materials, but preferably the tablet case is constructed from a material that may provide impact protection to the tablet while inside the tablet case. It is contemplated that the tablet cases of the present disclosure may provide the computing device with additional futures, such as additional imaging units, to expand functionality of the portable computing device. It should be noted that while the present description may refer to the computing device as a tablet computer or a tablet, the tablet cases of the present disclosure may be modified in size and shape for use with other portable computing devices, such as smart phones, as well as desktops and laptops.

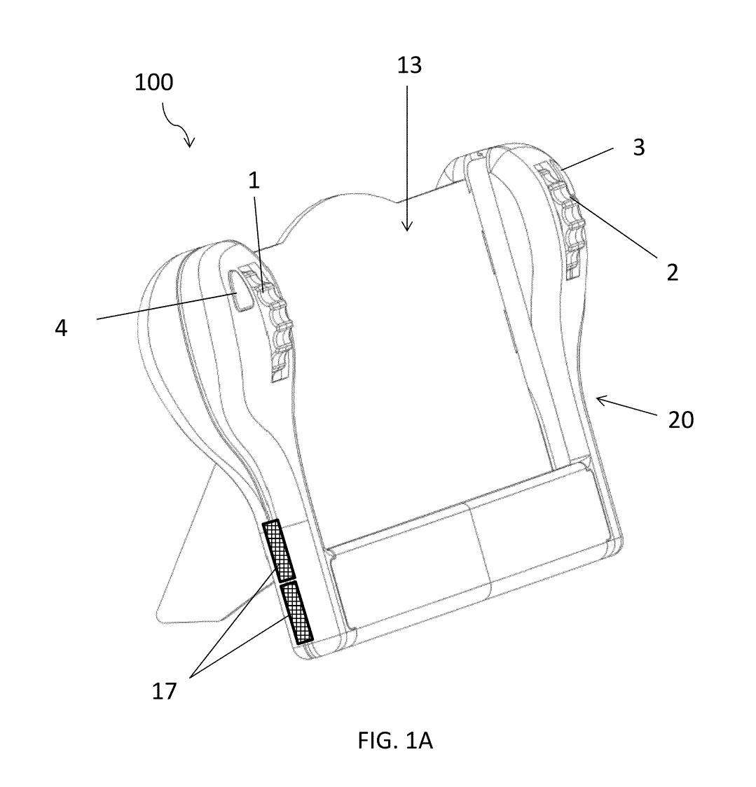

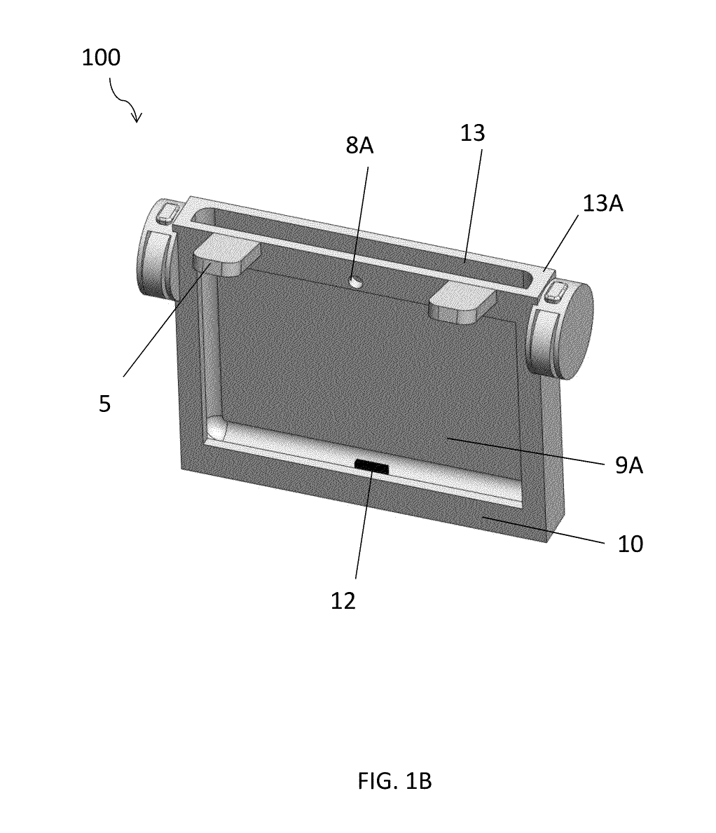

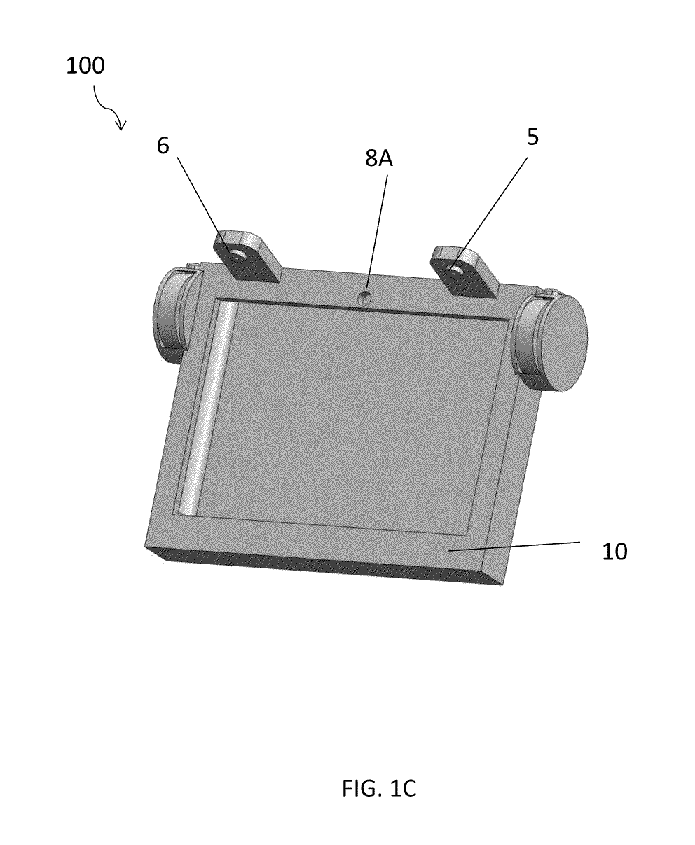

FIG. 1A illustrates an embodiment of a tablet case 100 of the present disclosure. The tablet case 100 may include a protective frame 20 defining a receptacle 13 into which a tablet computer may be inserted. The protective frame 20 may have various embodiments as long as it is able to protect the tablet computer received therein. The protective frame 20 may be designed to enclose the tablet computer either in part or in whole.

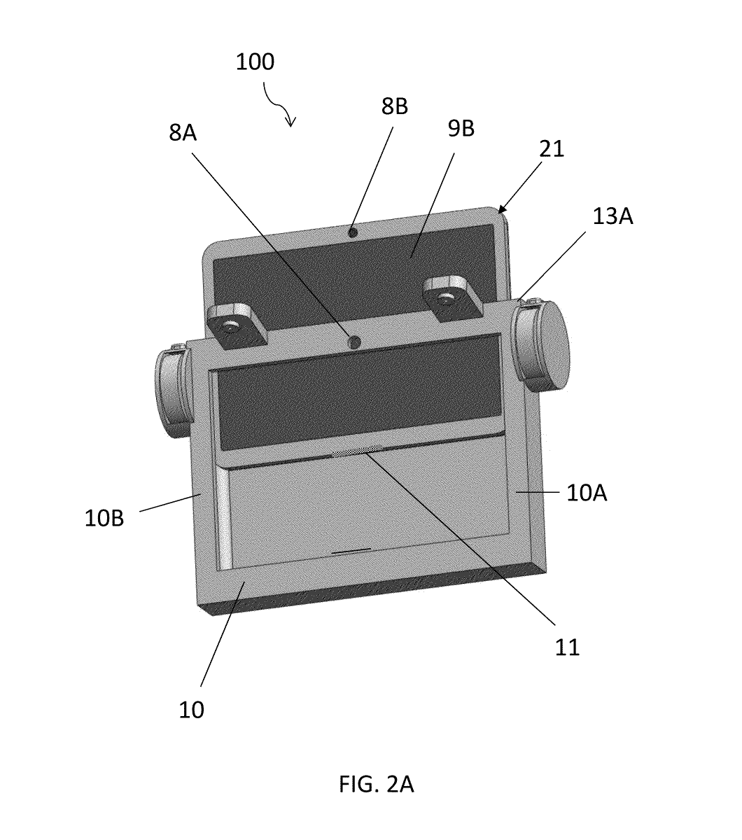

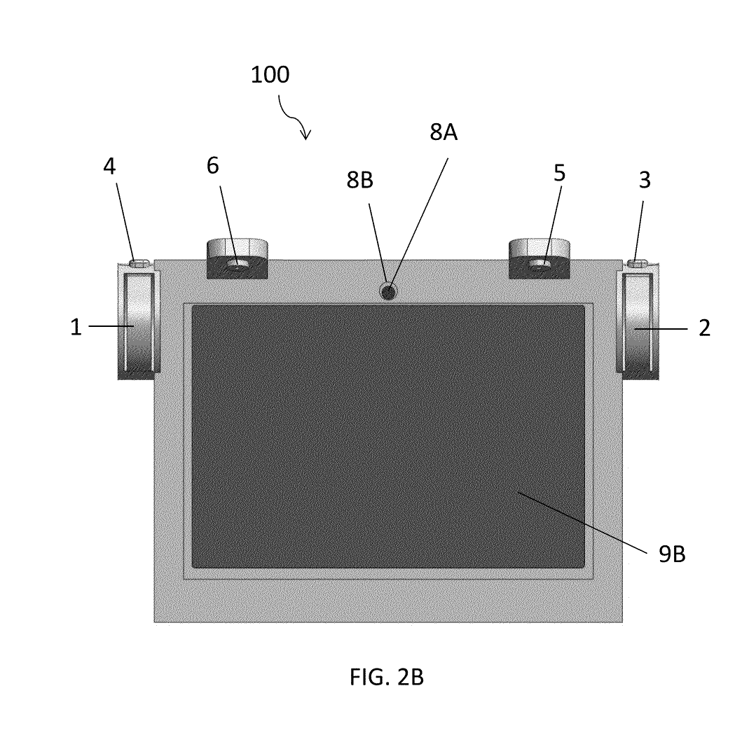

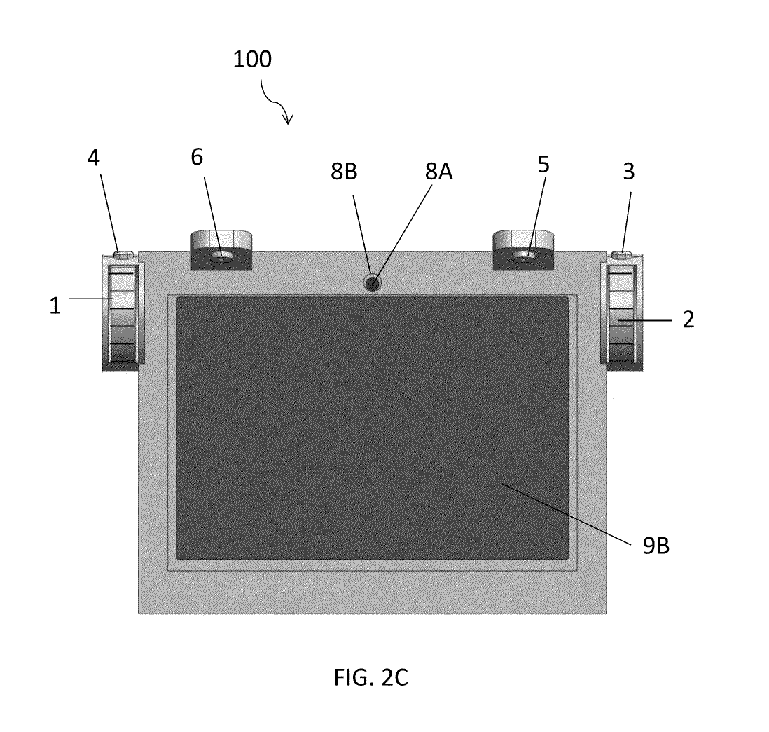

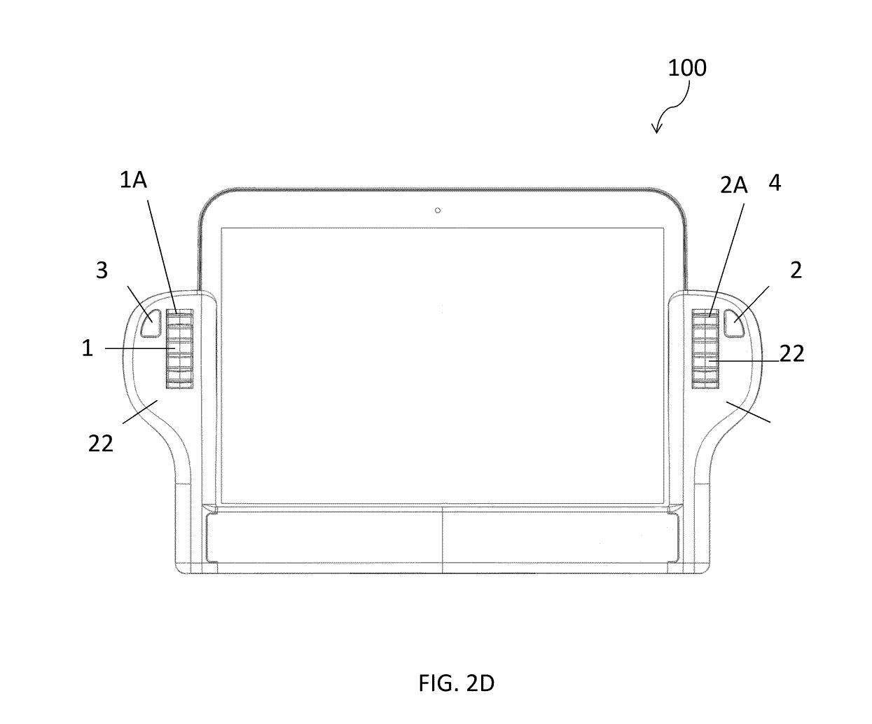

The tablet case 100 may include a connector 12 which can be connected to a tablet computer socket of the tablet computer when the tablet computer is inserted into the tablet case 100 (see FIG. 2B). In some embodiments, when the tablet is inserted and connected such connection may allow the user to operate the tablet computer 21 using controllers 1, 2, 3, 4 of the tablet case 100. The one or more controllers 1, 2, 3, 4 can simplify the operation of the tablet computer. In some embodiments, a simple controller or a processor may be provided to allow the one or more controllers to communicate with the processor of the tablet computer to enable the one or more controllers to control the functionality of the tablet computer.

In some embodiments, the one or more controllers may be rollers and buttons, but other designs for controller may be utilized. Because the tablet case 100 is in communication with the tablet computer 21, the software running on the tablet computer 21 can sense rotation and direction of the rotation of the rollers 1, 2 and press of the buttons 3, 4. For example, the one or more rollers 1 and 2 may be used for controlling, selecting, activating or deactivating, various functionalities of the tablet computer 21 associated with capturing and presenting the target image. Examples of such functionalities include, but not limited to, scrolling the captured image or text up/down on the screen, in a page-down and page-up or line up and line down manner; moving between menu items, scroll through telephone director or address book to another, scroll through image (for example, roller 1 does vertical scrolling while roller 2 does horizontal scrolling), zooming image in and out, controlling reading speed, changing font size and similar functions. In some embodiments, as the user rotates the one or more rollers 1, 2 icon or clickable images are highlighted on the screen 9B for selection by the user.

In some embodiments, the rollers 1, 2 having groves so as to assist the user with the rotation of the rollers 1, 2 (See FIG. 1A). However, it is contemplated other assistive rotation concepts or features may be incorporated into the rollers 1, 2. For example, the rollers 1, 2 may include a button in it. When a roller is pressed in (or forward), the button is engaged. The roller button may be included instead of or in addition to the thumb button over the roller. It is possible the roller may be replaced by a rocker switch or two buttons—up and down. Further, the rollers may produce clicks per certain angle, when spun. When the roller makes a click it is possible to cause an action (such as intermittent scroll).

In some embodiments, the buttons 3, 4 may be assigned a select function for selecting items from a menu. These buttons 3, 4 may also be used for functions such as volume control (some of the buttons may be rotary knobs) of voice/speech output (audio), speed control of voice/speech output (audio), snapshot, mode switching, magnification control, brightness, contrast. In some aspects, the buttons 3, 4 may be used to prompt a controller of the tablet computer to provide audio output of the selected portion to the user.

In some embodiments, the communication between the tablet computer 21 and the tablet case 100 may be through a wireless connection such as Bluetooth or WiFi. In some aspects, the tablet case 100 may include a plurality of ports 17 for connecting the tablet computer 21 to external devices and power sources. In some embodiments, the tablet case 100 may include one or more USB, VGA, HDMI, Ethernet, and other ports 17 for connecting the tablet computer 21 to an external device, including, but not limited to, external data storage, phones, computers, speakers, televisions, monitors, printers and similar devices. The tablet case 100 may further include one or more ports for insertion of a smart card, memory or the like.

In some embodiments, the tablet case 100 can have a pass through power connector to enable the tablet computer to be charged while in the tablet case. In some embodiments, the tablet case can have a pass through data connector to enable the user to upload data to or download data from the tablet, when the tablet computer is inside the tablet case. In some embodiments, the tablet case may include a compartment for storage of batteries, which may be used for charging the tablet computer.

In some embodiments, the tablet case 100 allows the user to comfortably hold the tablet case 100 with the tablet computer in it (see FIG. 2B). For example, the tablet case 100 may include a handle to allow the user to carry the tablet case 100 with the tablet computer in it. It is possible, the tablet case 100 may be designed so it can be positioned vertically on a flat surface to stand by itself, such as on a table, a desktop or a counter. It is contemplated, the tablet case 100 may be designed to be placed at an angle to the flat surface to allow the camera of the tablet computer to view a target placed on the flat surface. Also placing the tablet at an angle to the surface may allow the user to comfortably view the screen. It is also possible that the tablet case 100 may be structured and designed with a built-in or detachable/adjustable stand, as is described below, to adjustably position the tablet case 100 on a non-linear surface to allow the camera of the tablet computer to view the target at a multitude of angles.

FIG. 1B and FIG. 1C illustrate an embodiment of the tablet case 100 having one or more imaging units 5, 6. The tablet case 100 may have a receptacle 13 in a top wall 13A for inserting a tablet computer or tablet into a tablet holding compartment of the tablet case 100. However, the receptacle 13 may be located on a wall other than the top wall 13A. Further, the tablet case 100 may include one or more cut-outs to enable the user to operate various features of the tablet computer inside the tablet case 100. For example, a front wall 10 of the tablet case 100 may include a cut-out 9A for a screen of the tablet computer (see FIG. 2A and FIG. 2B). The front wall 10 may also include a cut-out 8A for the camera of the tablet computer. Other cut-outs in the tablet case 100 are contemplated which can depend, among other things, on the type tablet computer used and/or the application. Further, the tablet holding compartment of the tablet case 100 may include a connector 12 which can be connected to a tablet computer socket of the tablet computer when the tablet computer is fully inserted into the tablet case 100 (see FIG. 2B). When such connection is made, the tablet computer 21 may be controlled with controllers of the tablet case 100. In addition, the imaging units 5,6 may also be in communication with the tablet computer 21 so the images taken by the imaging units 5, 6 can be displayed, saved, or otherwise manipulated on the tablet computer. The communication may be through the connector 12 or it can be through a wireless communication, such as WiFi and Bluetooth.

In some embodiments, the tablet case 100 may also have an ejection mechanism that helps to remove the tablet from the tablet case 100. The tablet case 100 may also be designed to allow the angle of the screen of the tablet to be adjustable while inserted in the tablet case 100, such that the user can see the tablet screen at a right angle while sitting in front of the tablet computer.

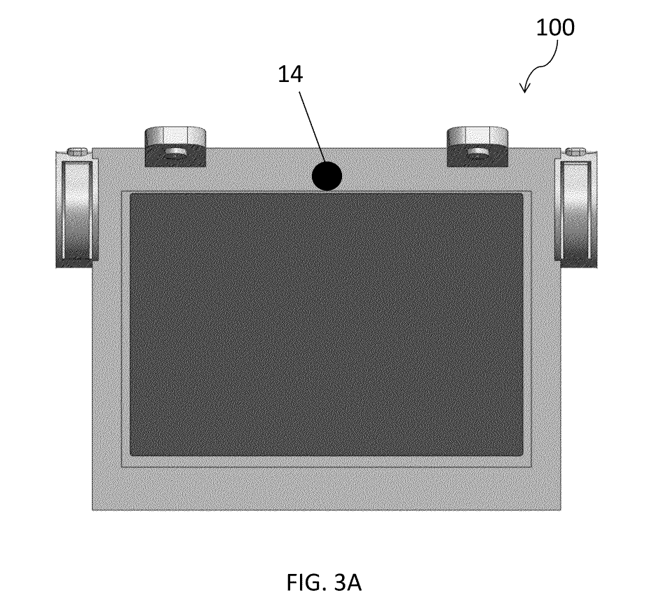

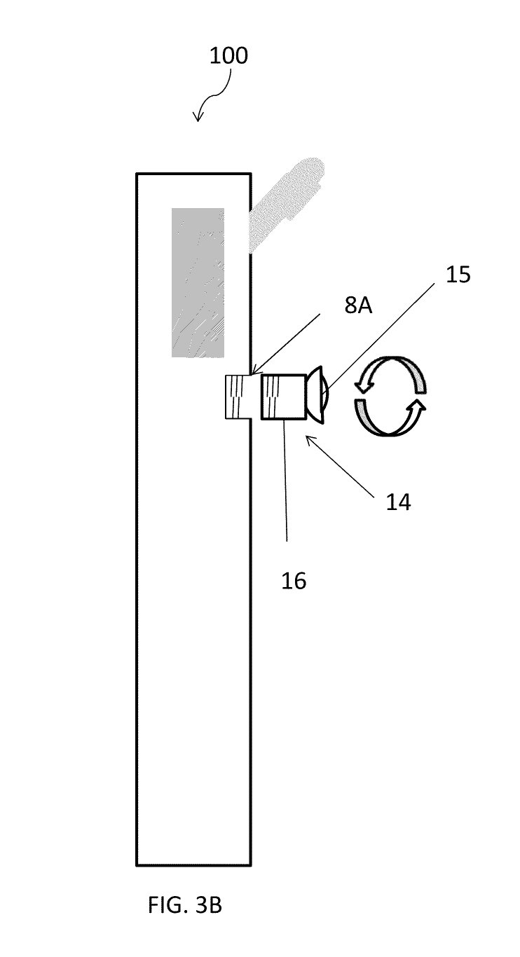

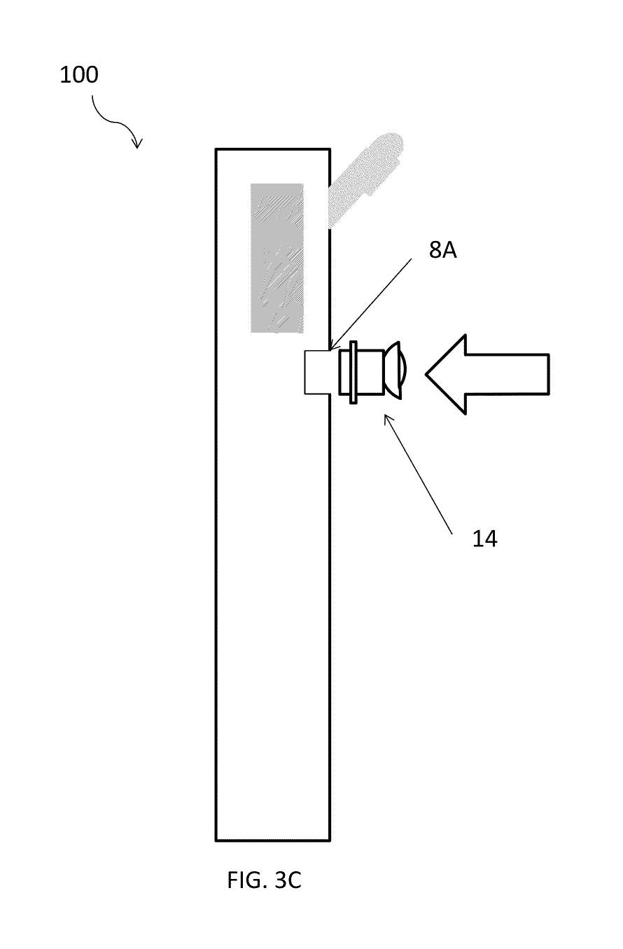

FIG. 2A illustrates tablet computer 21 such as an iPad, an Android or a Windows tablet computer that is partially inserted in the tablet holding compartment of the tablet case 100. The tablet case 100 may have a plurality of walls which essentially define the tablet holding compartment into which the tablet computer 21 can be inserted. For example, the top wall 13A, the front wall 10 and side walls 10A and 10B. In some embodiments, the tablet case 100 may be a frame to which the tablet computer 21 may be attached (see FIG. 3).

Still referring to FIG. 2A, the tablet computer 21 may include a built-in, forward facing camera 8B, a screen 9B and a socket 11. The socket 11 may be used for data transfer to and from the tablet computer 21 as well as to provide power for charging the tablet computer 21 when connected to the connector 12 of the tablet case 100. The tablet computer 21 may also have means for wireless transmission of data. In some embodiments, the tablet computer 21 may include a software application designed to capture a target image (text, indicia, graphics or other images) that the user needs to read or visualise from a target and present the target image to the user on the screen of the tablet computer.

FIGS. 2B and 2C illustrate a front view of the tablet computer 21 fully inserted into the tablet holding compartment of the tablet case 100. In this position, the socket 11 of the tablet computer is in communication with the connector 12. As described above, such connection between the tablet computer 21 and the tablet case 100 may allow the user to operate the tablet computer 21 using controllers 1, 2, 3, 4 (see FIG. 2B) of the tablet case 100 to simplify the operation of the tablet computer.

FIG. 2D illustrates an alternative embodiment of the tablet case 100 having handles 22, each with at least one button 3,4 along with the rollers 1, 2. In some embodiments, the rollers 1, 2 may have grooves 1A, 2A to aid in operation of the rollers 1, 2.

It is possible that the tablet case can include a docking station, which may include one or more imaging units. The docking station may also be configured to receive a tablet computer, with or without the docking station. Once in the tablet computer is in docking station, the user may be able to send a fax or scan a page using the tablet computer.

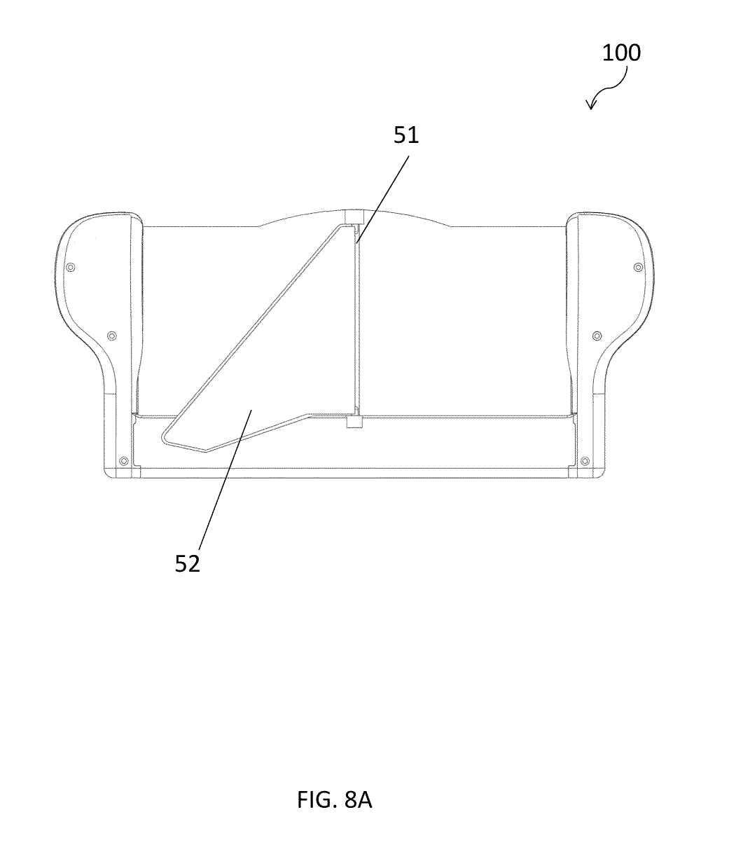

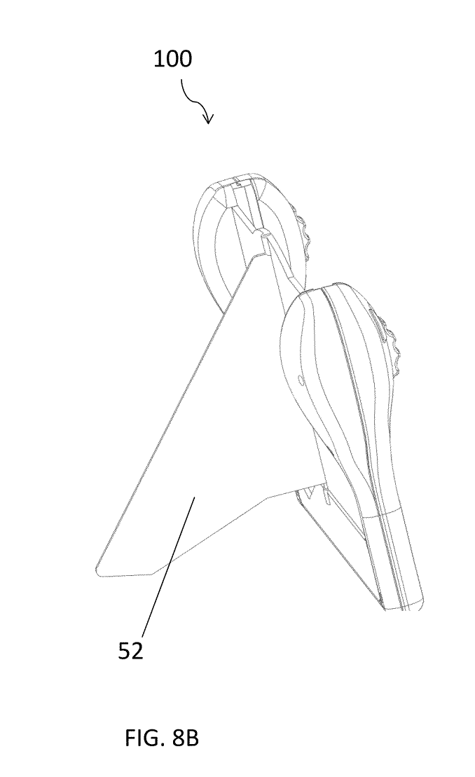

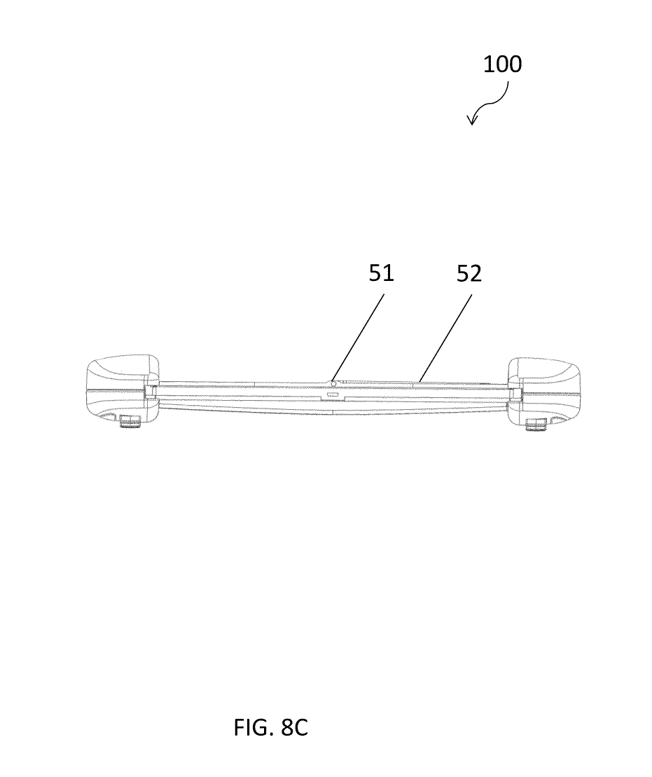

The user may also send a fax without a docking station assuming the embodiment has one or more cameras 5 and 6. The tablet case then should be substantially vertical. That can be achieved with the foldable support 52 on FIG. 8B

Still referring to FIG. 2B and FIG. 2C, the tablet case 21 may include one or more light sources adjacent to the one or more imaging units 5, 6 for illuminating the target. In some embodiments, the light source may include one or more light emitting diodes (LEDs). In some embodiments, the light sources may be spaced away from imaging units 5, 6 and may be shared by the imaging units 5, 6.

Still referring to FIG. 2B and FIG. 2C, the built-in camera 8B of the tablet computer 21 can be used as a magnifier. To this end, the software may be configured such that one of the rollers 1, 2 is used to control magnification, while the other roller can be used to control brightness, sharpness or colors. In some embodiments, a back camera may also be provided. In some embodiments, the back camera may be a high resolution camera for use as a magnifier, OCR or both.

Still referring to FIG. 2B and FIG. 2C, the tablet case 21 may have a lens that is placed over the built-in camera 8B of the tablet computer 21 when the tablet computer 21 is inserted into the tablet case 100. In some embodiments, such lens can aid the built-in camera 8B to focus on close up object or focus on a distant object, which can be controlled by rollers 1, 2.

FIG. 3A and FIG. 3B illustrate a lens adaptor system 14 that can be used in connection with the tablet case 100. The lens adaptor 14 may be engaged with the cut-out 8A of the tablet case 100. The lens adaptor system 14 may be arranged to align and secure the one or more lens in a particular direction, orientation and position with respect to the built-in camera 8B of the tablet computer 21 in the tablet case 100. For example, the lens adaptor system 14 can include one or more connector 16 to align and attach the one or more lens 15 to the tablet case 100 so as to enhance the imaging capabilities over a standard imaging system provided with the built-in camera 8B of the tablet computer 21. The one or more type of lens 15 may include, by non-limiting example, wide-angle lens, auto-focusing, zoom lens, telephoto lens or any other type of lens system arranged to enhance and/or alter images captured by the imaging of the camera 8B of the tablet computer 21. FIG. 3B illustrates the lens adaptor system 14 having the one or more connector 16 including a spirally grooved solid end on lens 15 and a correspondingly grooved cavity in the tablet case 100 into which the lens fits, such that when the lens 15 is fully screwed into the cavity, the lens is correctly aligned to the built-in camera of the tablet computer 21 as well as secured to the tablet case 100.

FIG. 3C illustrates one or more connector 16 including a protrusion at an end of the lens 15 and a corresponding cavity in the tablet case 100 into which the protrusion fits, such that when the lens 15 is fully inserted into the cavity, the lens is correctly aligned to the built-in camera of the tablet computer 21 as well as secured to the tablet case 100. Other connecting arrangements 16 are contemplated for attaching the one or more lens 15 to the tablet case 100 include built-in universal lens adaptors, spring activated connecting mechanisms or other similar related devices or mechanism to connect the lens 15 to the tablet case 100.

Still referring to FIG. 3A, FIG. 3B and FIG. 3C, it is contemplated that the one or more lens 15 may require power to operate. For example, the tablet case 100 may include a power source arranged to provide power to the lens through the lens adaptor system 14. However, it is considered that the tablet case 100 could provide power via electrical contacts directly from the tablet computer 21 and further provide power to the lens 15.

Referring back to FIG. 1B and FIG. 1C, the tablet case 100 with imaging units 5, 6 may be configured to capture a target image from a target (text, indicia, graphics or other images) and present the target image to the user. In some embodiments, this may be used by people with vision impairments. For example, the target image may be captured by using a built-in camera of the tablet computer (see FIG. 2A) and/or, additionally or alternatively, the tablet case may also include one or more imaging units 5, 6 for capturing the target image. The number of imaging units may vary depending on, for example and among other things, a specific application, the type of the imaging units employed and/or the size or shape of the target. In some aspects, the tablet case 100 may include a single imaging unit or multiple imaging units, wherein it is possible each multiple imaging unit may provide a unique feature. See the Imaging Unit Section below for more detailed disclosure for capturing images of one or more targets according to aspects of the present disclosure.

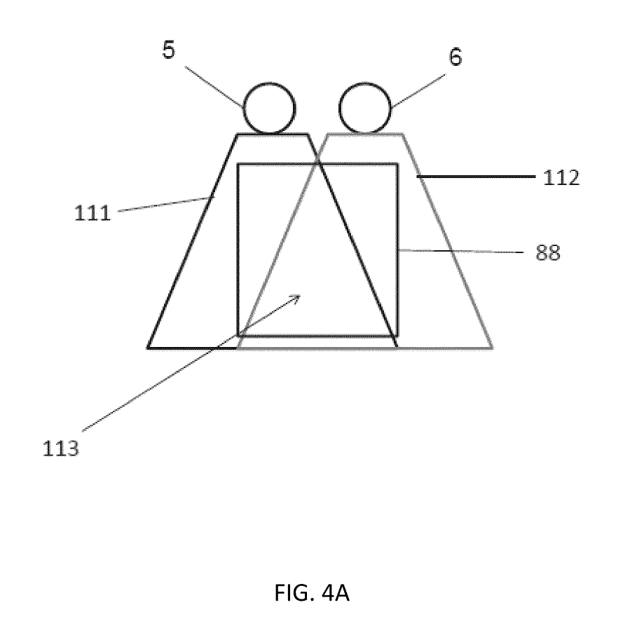

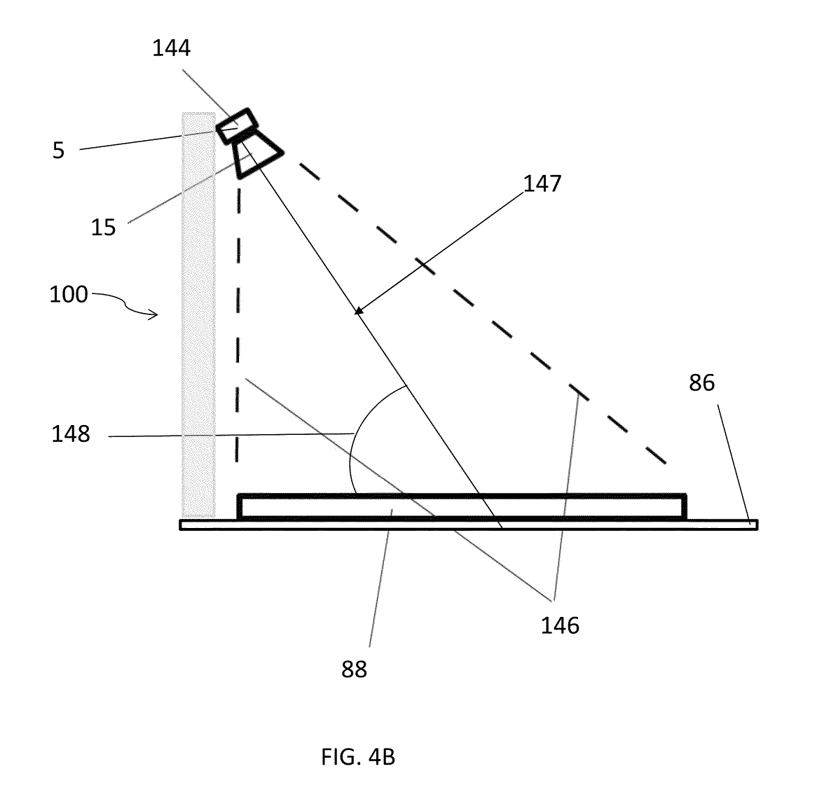

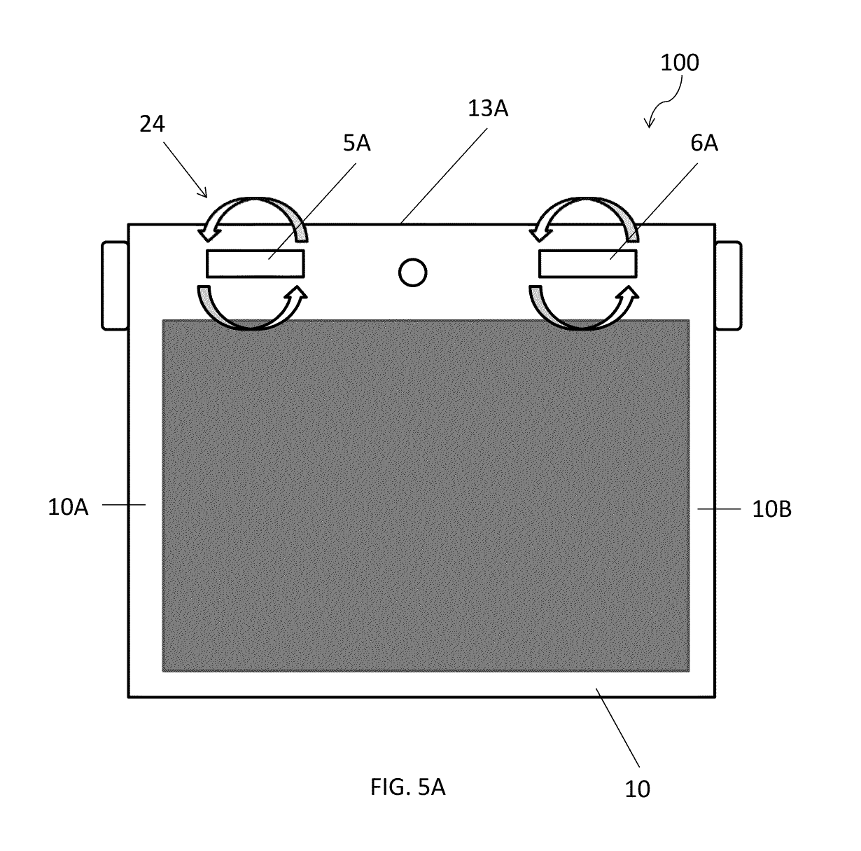

FIG. 4A illustrates a field of view (FOV) of the imaging units 5, 6 in an example of the embodiment with two imaging units. FOV of the two imaging units covers target 88. As noted above, the tablet computer 21 may be configured as an assistive device to capture the target image from the target 88 and present the target image to the user. In some embodiments, the target image may be captured by using the built-in camera 8B of the tablet computer 21, as noted above, and/or the tablet case 100 may also include one or more imaging units 5, 6 for capturing the target image.

Still referring to FIG. 4A, depending on the number of imaging units 5, 6 the type of the imaging units employed may vary due to the size and/or shape of the target 88. For example, the imaging units 5, 6 may be generally down-facing (but not necessarily pointed straight down) so that when the target case 100 is positioned vertically on a surface, the imaging units 5, 6 can capture the target images from the target 88 placed on the surface substantially perpendicular to the tablet case 100, as noted above.

Still referring to FIG. 4A, the imaging units 5, 6 may be positioned such that the fields of view 111 and 112 of the imaging units 5, 6, respectively, extend past the outer edges of the target 88 while providing an overlap 113 in the middle of the target 88. The overlap 113 between the fields of view 111, 112 should be sufficient to allow for alignment and stitching together the images captured by the imaging units 5, 6. Different types of software can be used for stitching images are contemplated. The overlap area 113 may include a sufficient number of features to enable reconstruction of the combined image from the imaging units 5, 6. If the overlap area 113 has sufficient number of features, it is possible to process the combining images from the imaging units 5, 6. The extent of the overlap area 113 may also be adjusted depending on the thickness of the target 88 or range of thickness of target 88. For example, as the thickness of the target 88 increases, the width of the overlap area 113 may be decreased.

FIG. 4B illustrates an embodiment having a down-facing imaging unit 5 with a lens 15 and a sensor 144. The lens 15 can generally be down-facing to capture an image of the target 88 placed substantially perpendicular to the tablet case. The lens 15 has a central axis or a lens axis 147 passing substantially through a center of the lens 15. The central axis or lens axis 147 forms an angle 148 relative to the surface 86 or target 88. As noted above, in some embodiments, the angle 148 can be an acute angle. The imaging unit 5, 6 has a field of view (FOV) 146 that covers the target 88, and potentially also covers additional margin to, for example, account for inaccurate positioning of the target or non-standard size of the target 88. To obtain a desirable FOV, the viewing angle of the imaging unit 5, 6, its distance away from the target 88, and its angle are taken into account. The distance of the imaging units 5, 6 from the surface 86 and an angle of the axis of the imaging units 5, 6 to the horizontal plane substantially perpendicular to the housing (for example, surface 86) may be a function of the viewing angle (A) of the imaging units 5, 6, the size of the target 88, and the number of imaging units used. Both the distance and lens axis angle can be adjusted for maximum performance. For example, decreasing the axis angle may improve effective resolution. As a result, the lens axis is not at the center-line of the target, but is closer to the edge which is closer to the imaging unit. By way of a non-limiting example, when employing two imaging units 5, 6, the two imaging units 5, 6 with viewing angle 60° may be positioned approximately 9.3 inches above the surface at an angle of approximately 17.6°, and distanced 5.25 inches from each other to cover a letter sized target with sufficient overlap.

Still referring to FIG. 4A and FIG. 4B, according to some aspects, the imaging units 5, 6 may be stationary and not rotatable or adjustable. In other aspects, the angle of the imaging units 5, 6 can be adjustable, which may facilitate capturing images from a target object placed at various angles relative to the tablet case 100. It is possible that the imaging units 5, 6 may be any camera such as, CMOS, CCD, or similar, which is capable of capturing still images or videos. The imaging units 5, 6 can be, independently of each other, auto-focused, manually focused, or have a fixed focus with a sufficient focus depth. In some embodiments, the focusing of the imaging units 5, 6 may be electrically controlled by the tablet computer.

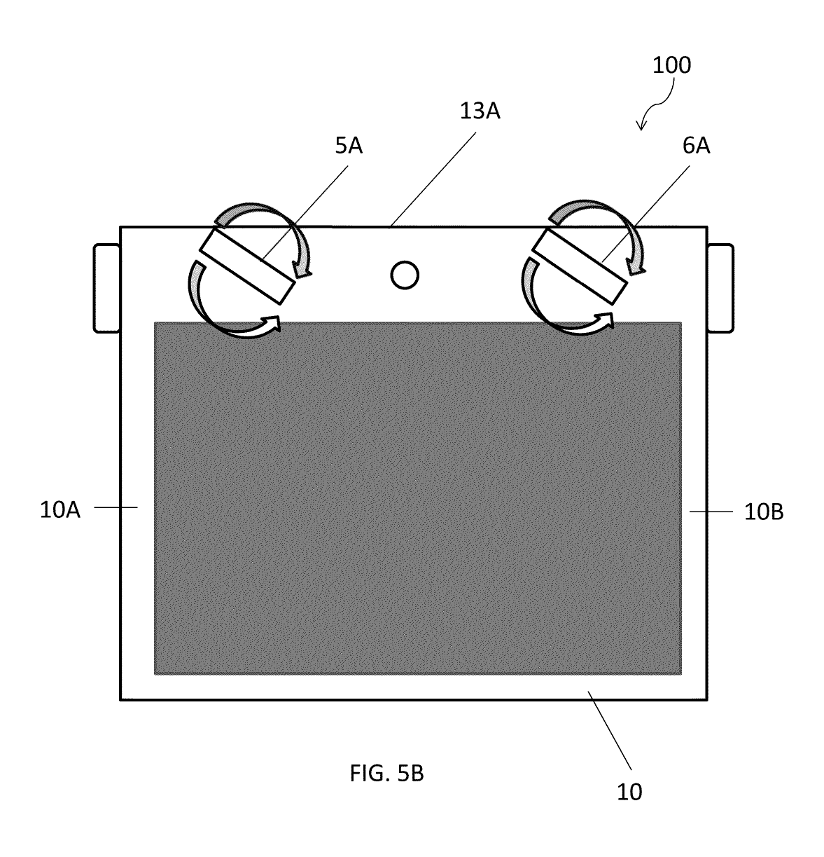

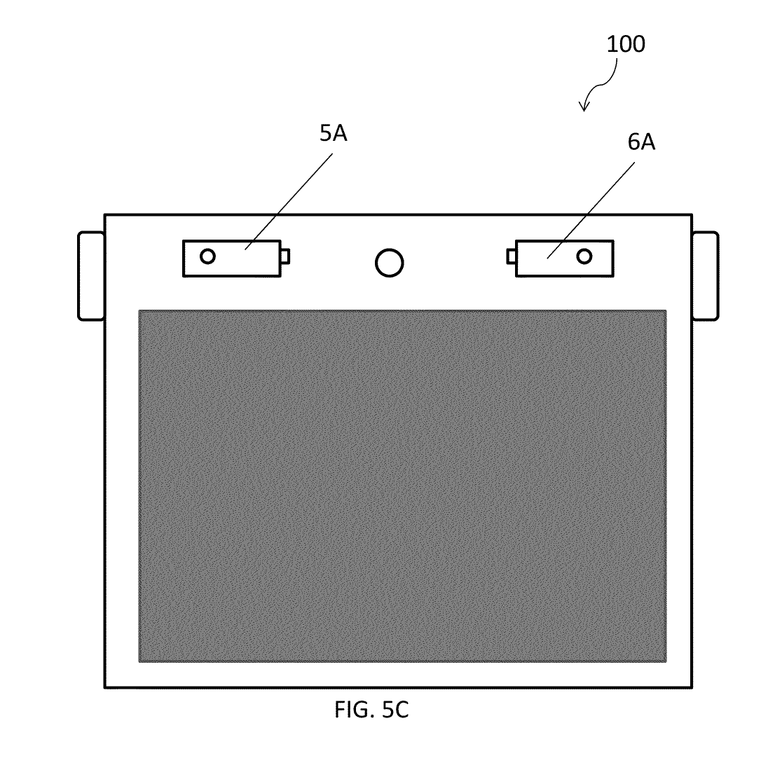

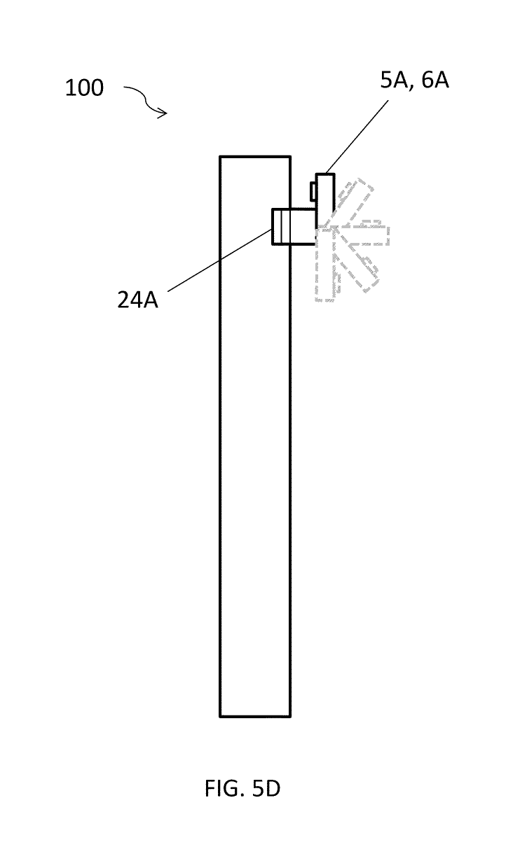

FIG. 5A and FIG. 5B illustrate imaging units 5, 6 as detachable imaging units 5A, 6A that can be attached to the tablet case 100 via an imaging adaptor system 24. FIG. 5A shows an imaging adaptor system that they can be arranged to align the detachable imaging units 5A, 6A in a particular direction, and orientation with respect to the surface of the target 88 when secured to the tablet case 100. For example, the imaging adaptor system 24 includes a rotatable portion that allows the detachable imaging units 5A, 6A to rotate when fixed to the tablet case 100 in two directions. FIG. 5B shows the detachable imaging units 5A, 6A partially rotated along an X-axis, wherein the first direction allows the detachable imaging units 5A, 6A to rotate 360° degrees along the X-axis (clockwise or counter-clockwise) or a plane which the detachable imaging units 5A, 6A are mounted to the tablet case 100. For example, the detachable imaging units 5A, 6A may be able to take images 360° degrees starting from a top view toward the top end 13A, to a side view toward a side 10B, to a bottom view toward the bottom 10, to another side view 10A and back to the top view of the tablet case 100.

FIG. 5C and FIG. 5D illustrate the second direction of the rotatable portion that can rotate the detachable imaging units 5A, 6A 180° degrees in a second direction along a Y-axis. For example, the detachable imaging units 5A, 6A would be able to take images from a 0° degree angle to 180° degree angle. FIG. 5C shows the detachable imaging units 5A, 6A at a 0° degree angle and FIG. 5D shows the detachable imaging units 5A, 6A at a 180° degree angle.

Still referring to FIG. 5A to 5D, according to an aspect of the disclosure, the detachable imaging units 5A, 6A can be oriented or directionally positioned so that when the target case 100 is positioned vertically on a surface, the detachable imaging units 5A, 6A can capture the target images from the target 88 placed on the surface substantially perpendicular to the tablet case 100, as noted above. However, it is possible for the detachable imaging units 5A, 6A to be oriented or directionally positioned so that when the target case 100 is positioned vertically on a surface, the detachable imaging units 5A, 6A can capture the target images of the target 88 when it is not placed on the surface substantially perpendicular to the tablet case 100 but at some other location in front of the tablet case 100.

Still referring to FIG. 5A to 5D, according to aspects of the disclosure, the imaging adaptor system 24 can include one or more connector 24A to align and attached the detachable imaging units 5A, 6A to the tablet case 100 so as to enhance the imaging capturing capabilities over fixed imaging unit(s). The detachable imaging units 5A, 6A may include one or more type of camera such as, CMOS, CCD, or similar, which is capable of capturing still images or videos, as noted above. The imaging adaptor system 24 can include different types of connectors 24A that attach the detachable imaging units 5A, 6A to the tablet case 100. For example, one connector of the one or more connector 24A may include a spirally grooved solid end of the detachable imaging units 5A, 6A and a correspondingly grooved cavity in the tablet case 100 into which the detachable imaging units 5A, 6A fit, such that when the detachable imaging units 5A, 6A are fully screwed into the cavity, the detachable imaging units 5A, 6A are correctly aligned to the tablet case 100. Another example of another connector of the one or more connector may include a cavity with a groove in the tablet case 100 that corresponds to a protrusion at an end of the detachable imaging units 5A, 6A, such that when the detachable imaging units 5A, 6A are fully inserted into the cavity and the protrusions are engaged within the grooves, the detachable imaging units 5A, 6A are correctly aligned in the tablet case 100. Other connectors 24A are contemplated for attaching the detachable imaging units 5A, 6A to the tablet case 100, which may include built-in universal detachable imaging unit adaptors, spring activated connecting mechanisms or other similar related devices or mechanism to connect the detachable imaging units 5A, 6A to the tablet case 100.

Still referring to FIG. 5A to 5D, it is contemplated that the one or more detachable imaging units 5A, 6A may require power to operate. For example, the tablet case 100 may include a power source arranged to provide power to the detachable imaging units 5A, 6A through the imaging adaptor system 24. However, it is considered that the tablet case 100 could provide power via electrical contacts directly from the tablet computer 21 and further provide power to the detachable imaging units 5A, 6A.

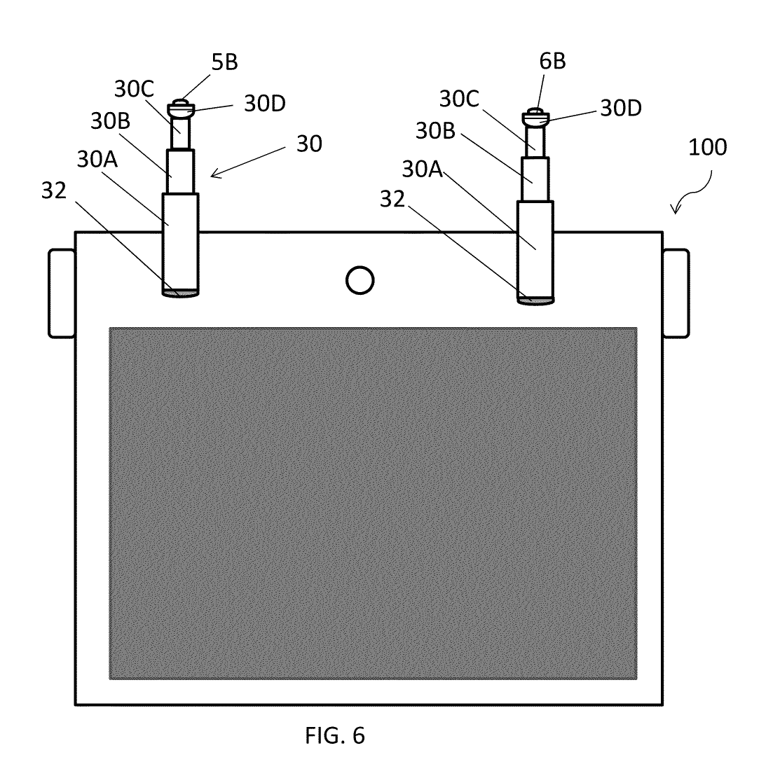

FIG. 6 illustrates telescoping arms 30 having a first section 30A, a second section 30B and a third section 30C, wherein the telescoping arm 30 is attached to the tablet case 100 via a ball joint rotating device 32. The telescoping arms 30 include imaging units 5B, 6B attached on an end of the telescoping arm 30. The imaging units 5B, 6B can be attached to the end of the telescoping arm 30 by a rotatory joint assembly 30D which can allow for the imaging units 5B, 6B to have two direction rotation along an X-axis and Y-axis direction, as noted above in regard to the characteristics of the rotatable portion of the imaging adaptor system in FIG. 5A. Further, the imaging units 5B, 6B can be powered by electrical contacts or connectors attached to the tablet case 100 as well as for transmitting captured images by the imaging units 5B, 6B, as noted above. It is contemplated the telescoping arms 30 could be incorporated into the tablet case 100 so as to snap into a groove (not shown) sized to flush fit the telescoping arms 30 with the front surface of the tablet case 100. It is also contemplated that the telescoping arms 30 could have one or more hinges to provide further mobility and extension of the telescoping arms 30.

According to aspects of the present disclosure, the configuration of either the rotatable features of the detachable imaging units 5A, 6A to rotate when fixed to the tablet case 100 in two directions and/or the telescoping arms 30 of the detachable imaging units 5B, 6B can provide for a greater adjustability of the fields of view 111 and 112 (see FIGS. 4A and 4B) over the imaging units 5, 6. Further, either or both of the two-direction rotation of the detachable imaging units 5A, 6A and the telescoping arms 30 of the detachable imaging units 5B, 6B can also provide for a greater adjustability of the overlap 113 between the fields of view 111 and 112 over the imaging units 5, 6. For example, the detachable imaging units 5A, 6A and/or the telescoping arms 30 of the detachable imaging units 5B, 6B have a field of view (FOV) that covers the target, and can also cover a greater margin over the margin of the fixed imaging units 5, 6, which can account for greater inaccurate positioning of the target or non-standard sizes of the target over the fixed imaging units 5, 6.

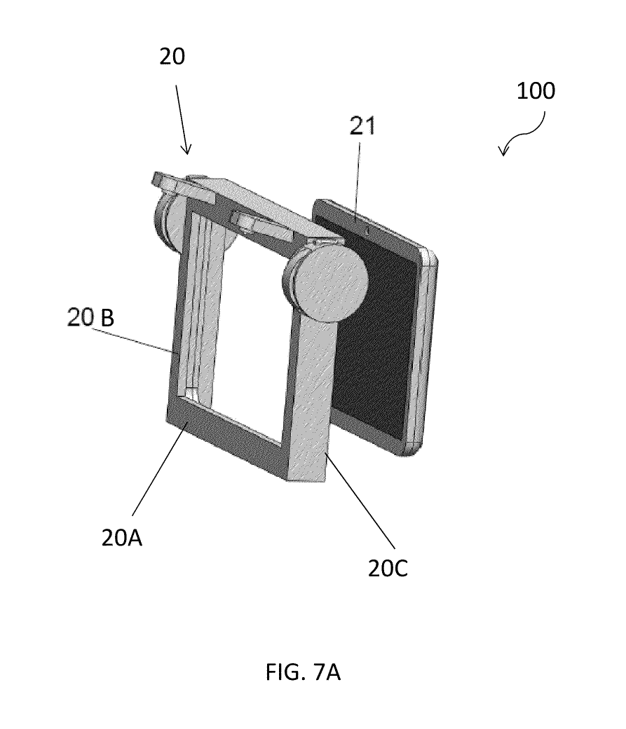

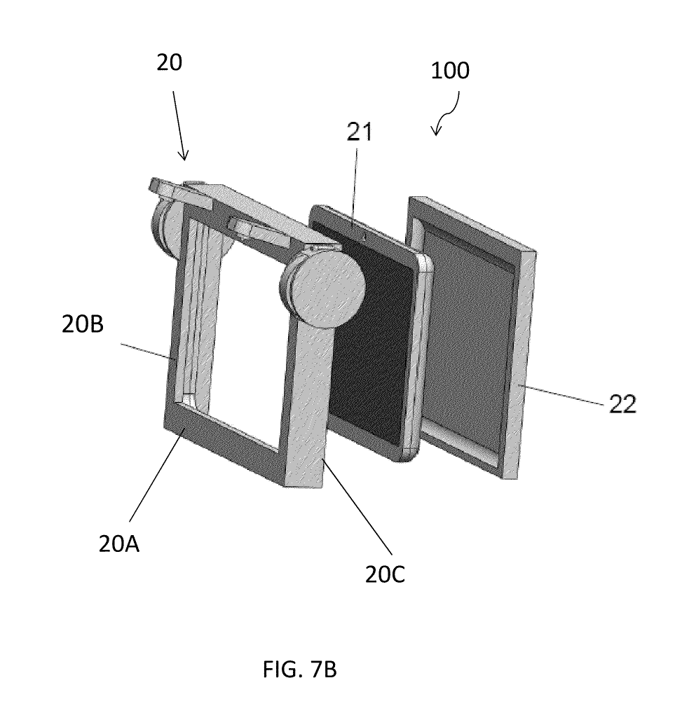

FIG. 7A illustrates the tablet case 100 including a frame 20 comprising a front wall 20A and two side walls 20B, 20C defining the receptacle 13. The tablet computer 21 can be snapped into the receptacle 13 of the tablet case 100 from the back of the frame 20. It should be noted that while FIG. 7A illustrates the tablet case having imaging units, a similar design may be used for the tablet case without the imaging units.

FIG. 7B illustrates another embodiment of the present disclosure, wherein the tablet case 100 including the frame 20 with the front wall 20A and two side walls 20B, 20C, also include an optional back wall 22. At least one aspect to having a back wall 22 could be for having an impact protection device/jacket for the tablet computer 21 inside the tablet case 100. Another aspect of back wall 22 may be to help hold the computing device 21 in place. It is possible that the back wall 22 can also be configured to position the tablet computer 21 vertically on a flat surface. Alternatively, the back wall could be designed to fit vertically on a surface that is not flat depending on the application. The tablet case 100 also can have an ejection mechanism (not shown) that helps to remove the tablet computer 21 from the tablet case 100. The tablet case 100 may also be designed to allow the angle of the screen 9B to be adjustable such that the user can see the screen 9B at the right angle while sitting in front of the tablet computer 21.

FIGS. 8A, 8B and 8C illustrate the tablet case 100 having a foldable support 52 attached to the tablet case 100, for example the foldable support 52 can be attached by a hinge 51 wherein the hinge 51 is fixed to the tablet case 100. In this way, when the foldable support 52 is unfolded, the tablet case 100 may be placed on a flat surface such as a table in an upright position. FIG. 8C shows the foldable support in a folded state.

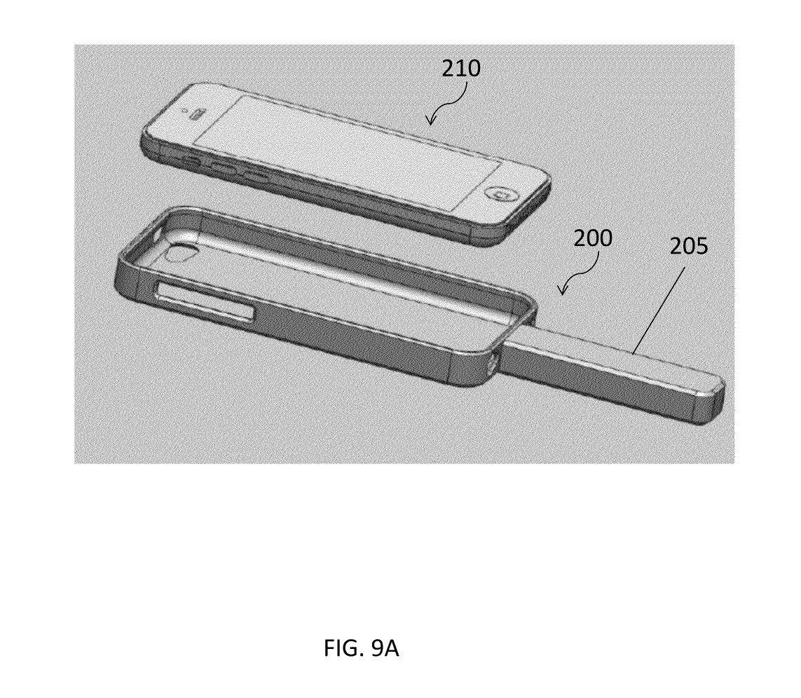

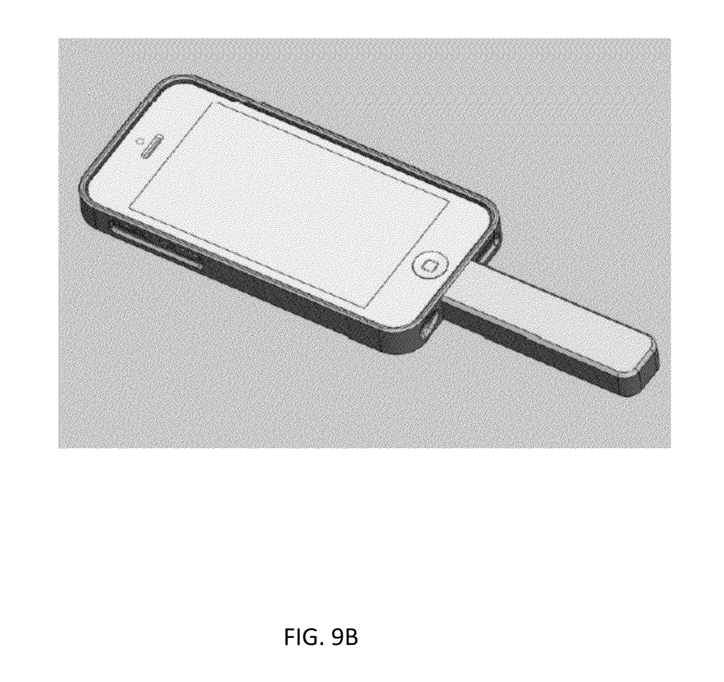

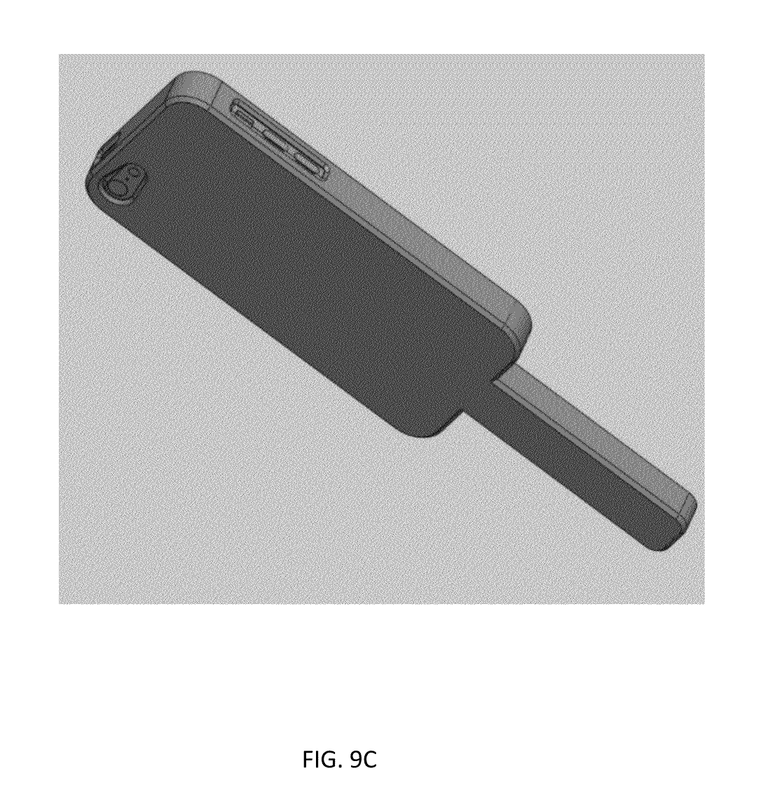

FIGS. 9A, 9B and 9C illustrate an alternate embodiment including a tablet jacket 200 to receive a smart phone 210. FIG. 9A shows the smart phone 210 outside of the tablet jacket 200. FIG. 9B shows a front view of the smart phone 210 in the tablet jacket 200. FIG. 9C shows a rear view of the smart phone 210 in the tablet jacket 200. The smart jacket 200, in some embodiments, can have a handle 205 which may replace a magnifier. The handle 205 may be foldable (not shown) and may include one or more buttons (not shown) to control an image taken by a built-in camera or case cameras in the smart phone 210. In some embodiments, the tablet jacket 200 may be modified for other portable computing devices, including laptop and game consoles.

According to some embodiments, the tablet case 100 of the present disclosure, with or without the imaging units, may be provided with a simplified user interface 23.

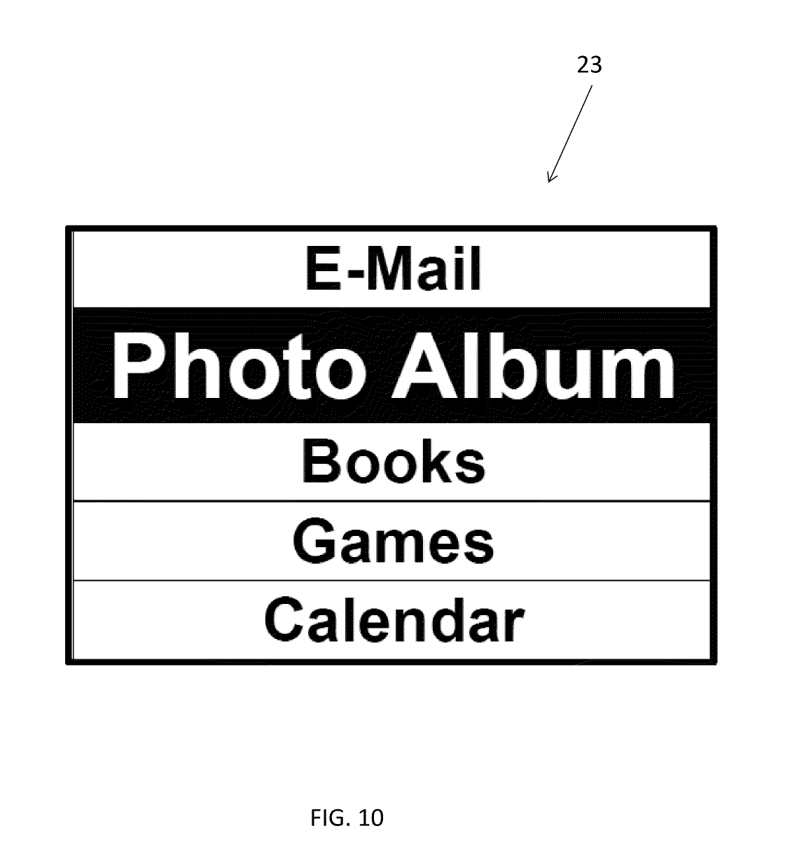

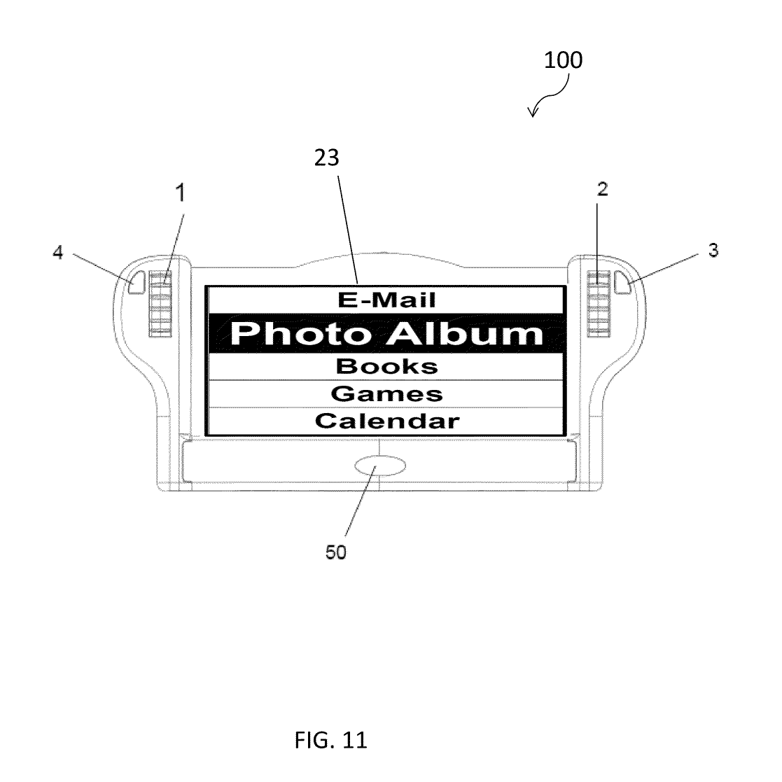

FIG. 10 and FIG. 11 illustrate a user interface (UI) layer that may be provided to further simplify the use of the tablet computer. For example, the UI may be provided on the tablet computer 21 such that when the tablet computer 21 is connected to the tablet case 100, the simplified user interface 23 can be used instead of the original or native icons of the table show a simple menu, as shown in FIG. 11. The one or more controllers 1, 2, 3 and 4 can be used to operate the tablet computer through the simplified interface 23. The menu may be textual or graphical. Menu items may be vertical or horizontal, or may be in 2d. In some embodiments, the UI of the present disclosure may include a selective menu where items may be changed to a different one and selected with a controller. The one or more controllers of the tablet case 100 may be used to control the tablet computer using the simplified interface of the present disclosure. The touchscreen functionality may be disabled, however in some cases the UI may enable limited touchscreen functionality. In some embodiments there may be an option to enable touch screen. For example there may be a menu item that enables touch screen. By way of a non-limiting example, one of the rollers may be used to scroll up or down and select the active items on the menu. In some embodiments, one of the buttons may be used to execute the active item on the menu. Another roller may be used to change the size of the font.

In some embodiments, the user interface may support applications specifically prepared for users of the presently disclosed devices, as well as applications native to the tablet. For example, because many users of the presently disclosed embodiments may not be comfortable with computers, a number of simple applications may be included for such users. Such applications may include a simplified email application, simplified calendar and similar.

E-mail is one of the examples of the specifically prepared application. The e-mail application can work in conjunction to the address book. The address book includes names and e-mail addresses. The user can send and receive e-mail only from the people in address book, thus elimination all unwanted e-mails. Also, when user sends an e-mail, he has an option to send email in a form of an image taken by imaging units 5 and 6 and audio recording, eliminating the need to type.

In some embodiments, the user interface may also provide means for the user to launch one or more native applications on the tablet, for user comfortable with such an application. Examples of native application include, but are not limited to, an Internet browser, e-mail client, settings and similar applications. For example, main menu may include an item that launches native application. Or main menu may have a submenu of native applications. When user enters native applications submenu, the user may be presented with a list of native applications present on the tablet. The user may select one of the applications in the list using the controllers (rollers and buttons) of the tablet case. The native application may be launched, and act as it was launched normally. The touchscreen at this point may be enabled or disabled according to the requirements of the application. When the user is done using the selected native applications, the user can press a button, and application can be closed or placed in the background, and user can be returned to the user interface. Also for some of the native applications it may be possible to keep touchscreen disabled, and application can be controlled via controllers described earlier.

Not all of the native applications present on the device maybe available to the user. For example, there may be a setting that selects which native application is available and which is not available to the user.

In reference to FIG. 11, a button 50 that may be provided to switch between the native applications and the user interface. Button 50 may be a regular button on the frame 20. In some embodiment, it can be simply a whole over a “home” button on the tablet computer. In some embodiments, button 50 can be a mechanism that is pressing on the “home” button of the tablet computer. The native applications that can be launched by the user can be enabled or disabled by the user interface settings. The separate settings may make a list of native applications and mark each as enabled or disabled. If application is disabled, it will not show up in the native applications list and user will not have an option to launch it.

In some embodiments, such interface may assist the user in searching for documents on the Internet. In some embodiments, the built-in camera can be used to take snapshots and OCR a portion of a page in a book, a magazine or a newspaper. Since the tablet computer can be connected to the Internet, the tablet computer can be programmed to search for a recognized text, and get a full article from the Internet.

It is possible, for the tablet computer to be programmed to determine or detect whether the tablet computer is or is not inserted into the tablet case. For example, when the tablet computer is inserted into the tablet case, the user interface on the tablet computer may switch to an assistive interface to assist the user to capture a target image from a target and present the target image to the user. On the other hand, when the tablet computer is removed from the tablet case, the tablet computer may switch back to its standard user interface.

In some embodiments, the user interface may include applications for facilitating communication between the user's tablet and third parties, such as medical personnel. For example, such applications may allow medical personnel to program the assistive device to remind the user about upcoming appointments or when to take medication. In some embodiments, such applications may aid the user to communicate with medical personnel or provide or request information from medical personnel.

In some embodiments the software may be controlled remotely by the third party. For example the third party can be enabled to upload pictures, books, movies, and other content to the embodiment. Also the third party can set up entries that trigger reminders. The reminder may remind the user of something by means audio or visual alarm. In addition the reminder can be set such that it requires the user to acknowledge the reminder. For example it may require the user to press a button or a combination of the buttons. The alarm may be set up such that the third party receives a notification if the user did not do an acknowledge action within certain time.

The remote control of the content of the device by third party is achieved via utilization of a central server. Each user has an account on the server that represents a device. The third party needs to log in to the account. Once logged in, the third party can upload the content (content includes reminders). The device is periodically synchronizing with the server. Synchronization may be triggered by the user or it can be periodic. The synchronization may be full or the device can check for the differences and synchronize only what was changed on the server.

In some embodiments, the tablet case 100 may be integrated as one piece with the computing device.

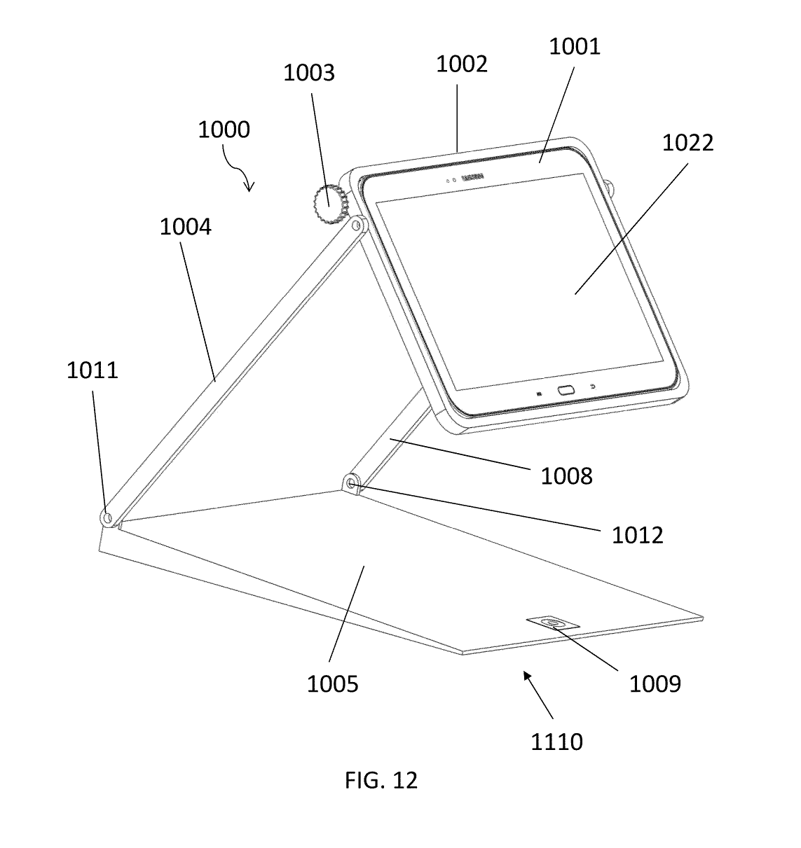

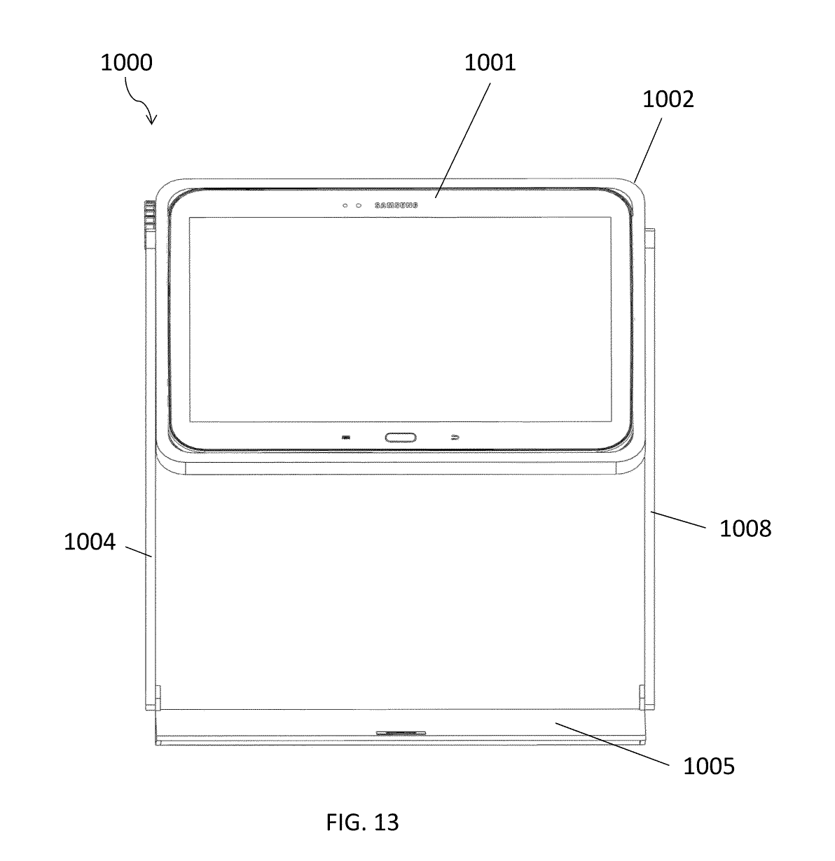

In reference to FIG. 12 and FIG. 13, a stand 1110 may be provided for use with the tablet case 100 of the present disclosure. In some embodiments, the stand 1110 may include a base 1005, a holder 1002 configured to hold the tablet computer 21, and one or more arms 1004, 1008 which connect the holder 1002 to the base 1005. In some embodiments, various embodiments of the tablet case 100 may be used as the holder 1002.

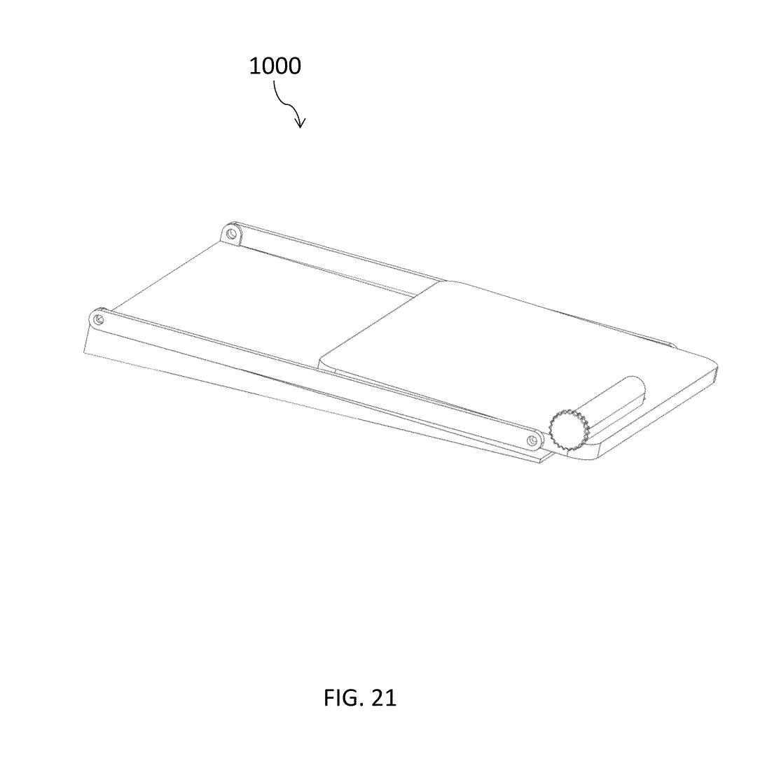

In some embodiments, the one or more arms 1004, 1008 may be connected to the base 1005 by hinges 1011, 1012 to enable the one or more arms 1004, 1008 to rotate relative to the base 1005. In some embodiments, a single arm may be provided, while in other embodiments, a plurality of arms may be provided. In some embodiments, the one or more arms 1004, 1008 are rotatable relative to the base 1005 to enable the stand to be folded for easier transporting, such as for example, shown in FIG. 21. In some embodiments, the one or more arms 1004, 1008 may be stationary relative to the base 1005. Similarly, the holder 1002 may be either rotatable or stationary relative to the one or more arms 1004, 1008. In embodiments, where the arms, the holder or both are rotatable, the range of the movement of the arms, the holder, or both may be limited (by for example providing stoppers at the hinges 1011, 1012 or the hinges connecting the holder 1002 to the one or more arms 1004, 1008) to enable the user to position the holder at a desired location and angle relative to the base 1005. In some embodiments, the one or more arms 1004, 1008 may comprise of multiple sections.

In some embodiments, the tablet computer 21 located in the holder 1002 is positioned to read an image (text, indicia, graphics or other images) from a target image positioned on a top surface of the base 1005. In some embodiments, the tablet computer 21 may include a backward facing camera and a forward facing screen. In such embodiments, the holder 1002 and the tablet computer 21 may be positioned at an angle relative to the base such that the screen of the tablet computer 21 is generally forward facing to enable the user sitting in front of the vision assistive device to ergonomically read from the screen of the tablet computer 21.

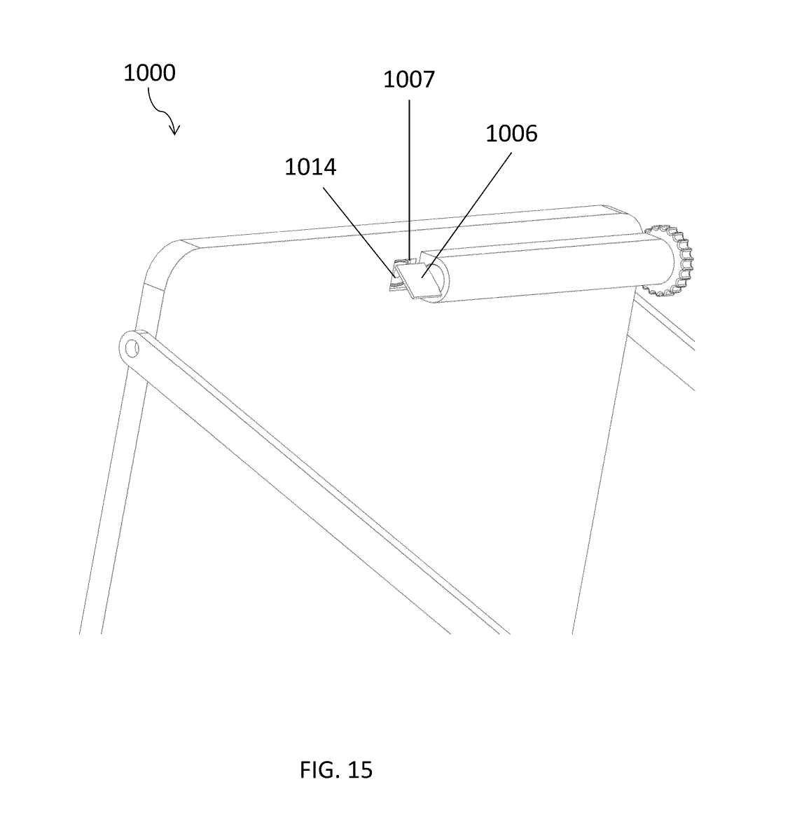

Computing devices 1001 typically include a camera 1014 (see e.g. FIG. 15) which can be used to capture an image from a target. The image can then be displayed on a display of the tablet computer 21 or read by the computing device to the user having a visual impairment. While the tablet computer 21 may be handheld by the user, it may be difficult to position the camera 1014 of the computing device at a correct distance and angle from the target to ensure that the image can be accurately captured (that is, without mistakes or omissions) and transmitted to the user. To that end, the stand 1110 of the present disclosure may be configured to hold the tablet computer 21 and position the computing device in an optimal location relative to the target image. In some embodiments, the stand 1110 positions the computing devices in a position optimal for user to see the screen.

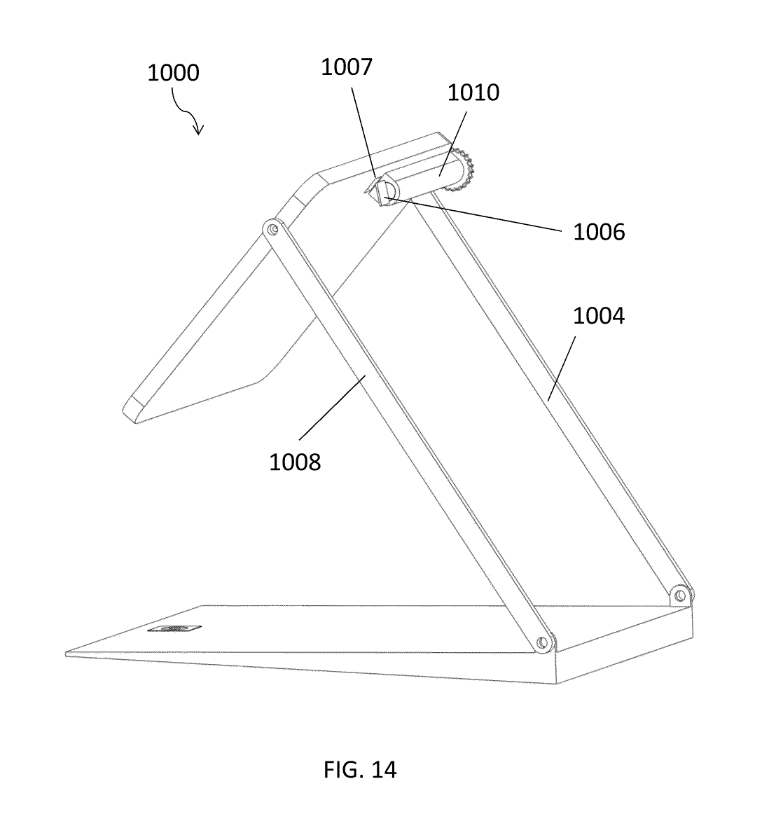

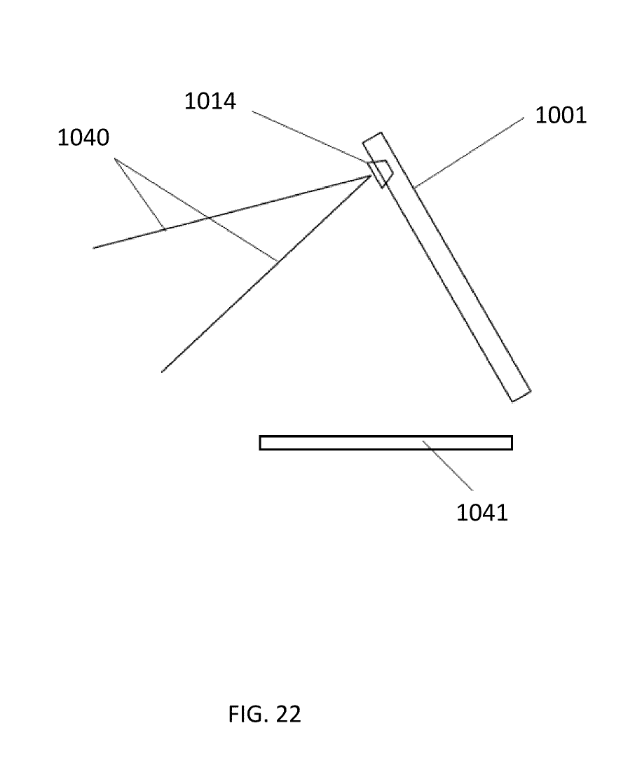

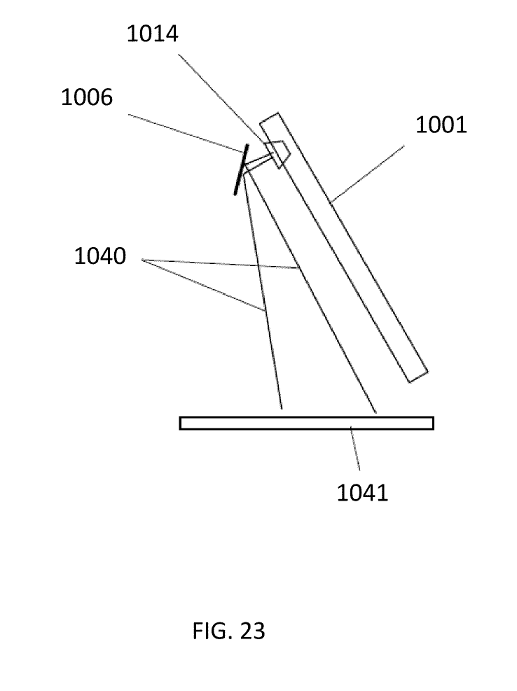

In reference to FIG. 14 and FIG. 15, because cameras in typical computing devices are stationary, with the lens axis being generally perpendicular to the back wall of the computing device, the camera 1014 of the computing device positioned at an angle allowing the user sitting in front of the vision assistive device to read from the screen of the tablet computer 21, may not be able to capture an image from a target placed on the top surface of the base 1005, as shown for example in FIG. 22, where the field of view 1040 of the camera misses the target 1041. However, if the computing device is rotated to enable the camera to capture such image, it may become difficult or uncomfortable for the user sitting in front of the vision assistive device 1000 to see the screen of the computing device because the screen may need to be facing upward. Accordingly, in some embodiments, the vision assistive device of the present disclosure may include a reflective member 1006, such as a mirror, to enable the camera 1014 to see an image outside its typical field of view. When the computing device is tilted into a comfortable viewing position for the user, the camera 1014 of the tablet computer 21 may not be able to see the target positioned on the base 1005 due to the angle of the computing device relative to the base 1005. The reflecting element 1006 may be used to place the target image into the field of view of the camera 1014 placed into a cut-out 1007 of the holder 1002, by reflecting the light from the target image to the camera 1014, as shown in FIG. 23.

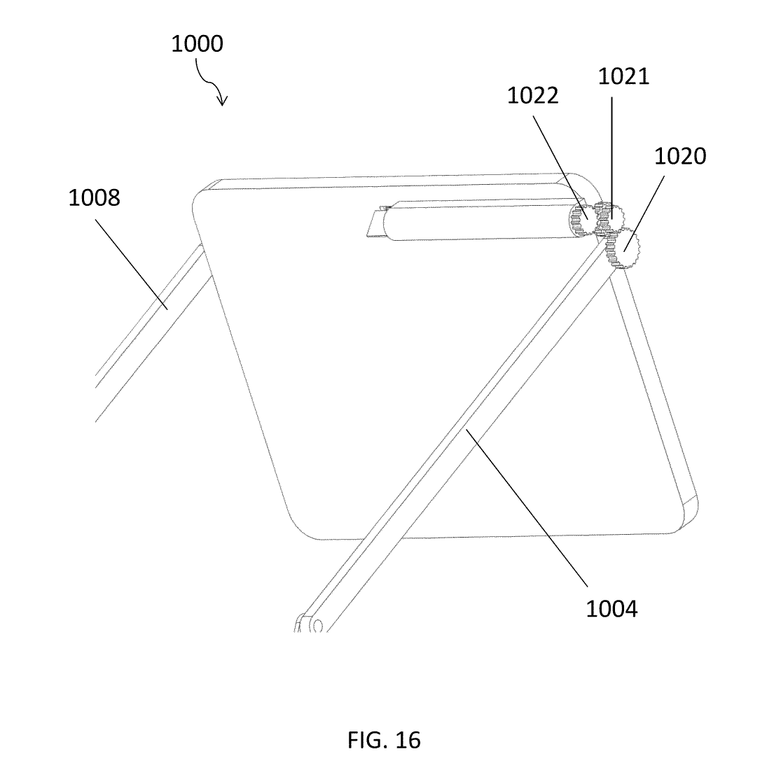

In some embodiments, the tablet computer 21 may be positioned at any angle relative to the base as desired by the user and the reflective member 1006 may be rotated to enable the camera to see the target image located on the base 1005. In some embodiments, a handle 1003 may be provided to control rotation of the reflective element 1006. In some embodiments, as shown in FIG. 16, a gear box may be placed into a housing 1010 to allow for finer adjustment of the mirror angle. For example, 5 degrees of rotation of the handle 1003 may result in one degree rotation of the mirror.

In reference to FIG. 16, in some embodiments, the reflective element 1006 may be adjusted automatically. By way of a non-limiting example, hinges 1011 and 1012 may be locked in a predefined position. Gear 1020 may be fixedly disposed on the arm 1004, while gear 1021 may be connected to the holder 1002 and may be engaged to gear 1020 and the handle 1003, which may be provided with teeth to mesh with gear 1020 and gear 1021. In this manner, when the holder 1002 is tilted by the user, the gear 1021 may be caused to spin, which in turn spins gear 1022 and rotates the mirror. In some embodiments, the housing 1010 may have an additional gear box that controls the angle of the reflective element 1006 and can angle the reflective element 1006 as desired.

In some embodiments, the vision assistive device may include software that enables automatic placement of the reflective element 1006 at a desired angle. By way of a non-limiting example, a motor may be provided in the housing 1010, and the motor may be controlled by the computing device. A unique label or painted picture 1009 may be disposed on the base 1005, as for example is shown in FIG. 12. The software that runs on the computing device runs an algorithm that identifies the unique label 1009. The software can spin the reflective element 1006 until the camera 1014 sees the label 1009 and sees it in a desired area of the camera view.

Some non-algoritming method embodiments may be used for tilting the reflective element 1006 to the correct position. One of the methods includes an accelerometer or other sensor that is measuring the tilt angle of the computing device and as a result an angle of the camera, which fixed to the computing device. As tilt angle of the computing device corresponds to one angle of the reflective element, the angle of the reflective element can be calculated using a formula or from the look up table. Since this calculation is simple, it can be performed on the software on the computing device or on the separate mirror and tilt sensor controller, which can be a microprocessor, PLD, FPGA or ASIC.

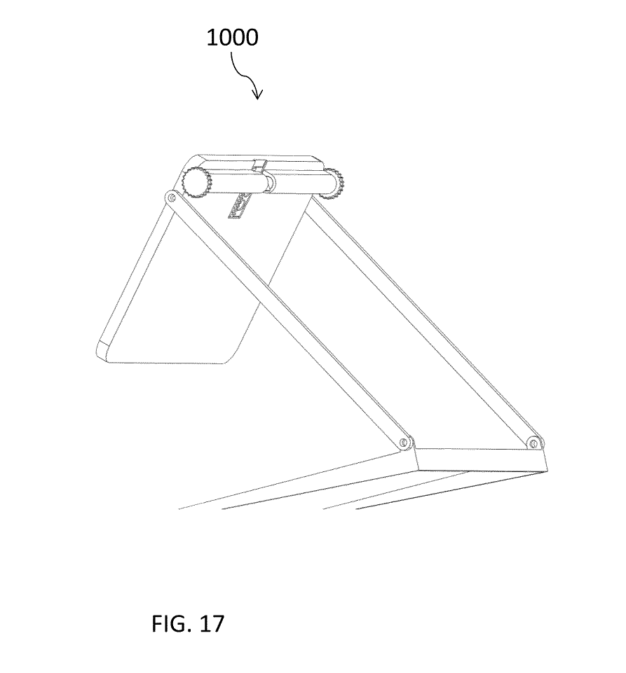

In reference to FIG. 17, in some embodiments, the vision assistive device of the present disclosure may include one or more additional lenses that can cooperate with the camera 1014 of the computing device to enhance operation of the camera 1014. For example, the camera 1014 may have either fixed or limited zoom, additional lenses may be needed in order to have either high magnification or full page view (low magnification). In some embodiments, additional lenses may be installed between the camera 1008 and mirror 1006. In some embodiments, the additional lenses may be interchangeable.

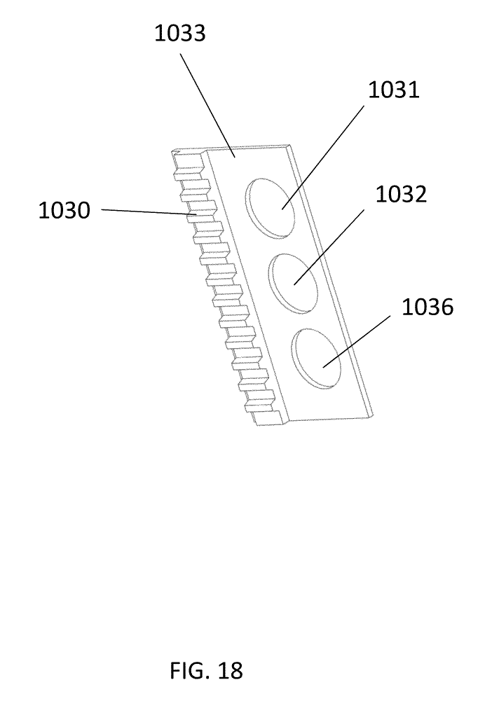

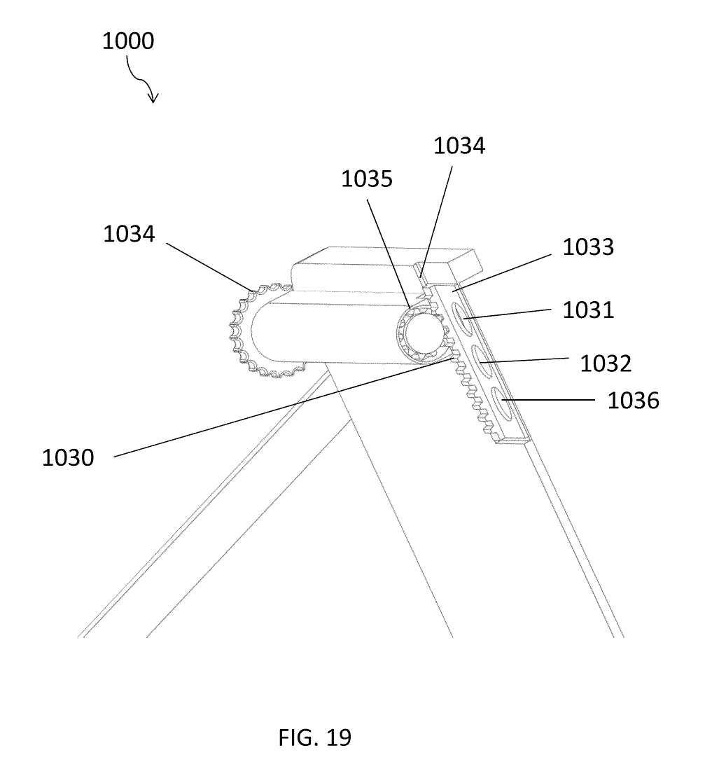

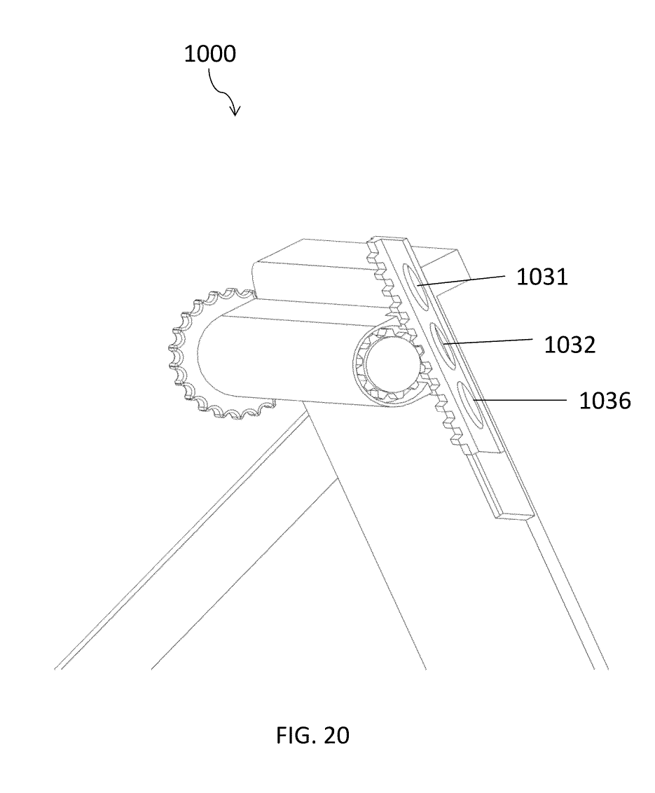

In reference to FIGS. 17-20, in some embodiments, 1003 additional lenses may be positioned on a strip 1033, having various lenses 1031, 1032, 1036. The strip 1033 may be inserted into a receptacle 1034 in the holder 1002. Gear 1035 may be provided to move lens strip 1033 up and down so a desired lens is placed in from of the camera 1014. In some embodiments, the gear 1035 may be moved with a handle 1034. In some embodiments, dimples to identify that one of the lenses is in the proper position in front of the camera 1014 may be used. The switching of the lens may be either automatically controlled or manually controlled.

FIG. 17 illustrates a manual handle that switches the lens. Electric motor can be used to switch lenses automatically. Such a motor can be controlled by computing device.

The tablet computer 21 of the vision assistive device 1100 may also include software for controlling various functionalities of the vision assistive device 1100. In some embodiments, the tablet computer 21 may receive data from the camera 1014 corresponding to the captured image, process the data, and output the data to the user. In some embodiments, the captured image from the target object may be displayed in an enlarged format in video mode (CCTV), showing the captured image magnified. In some embodiments, especially when the image includes a text portion, the captured image may be segmented into text and graphics. The text portion may then be further processed, as necessary, such as to reduce blur, skew, and distortion, to prepare the text for optical character recognition (OCR). Upon applying OCR, the text may be outputted in a visual form on the screen of the tablet computer 21. In some embodiments, the software may include text-to-speech conversion capabilities to enable the vision assistive device 1100 to read the OCRed text to the user through a speaker in the tablet computer 21.

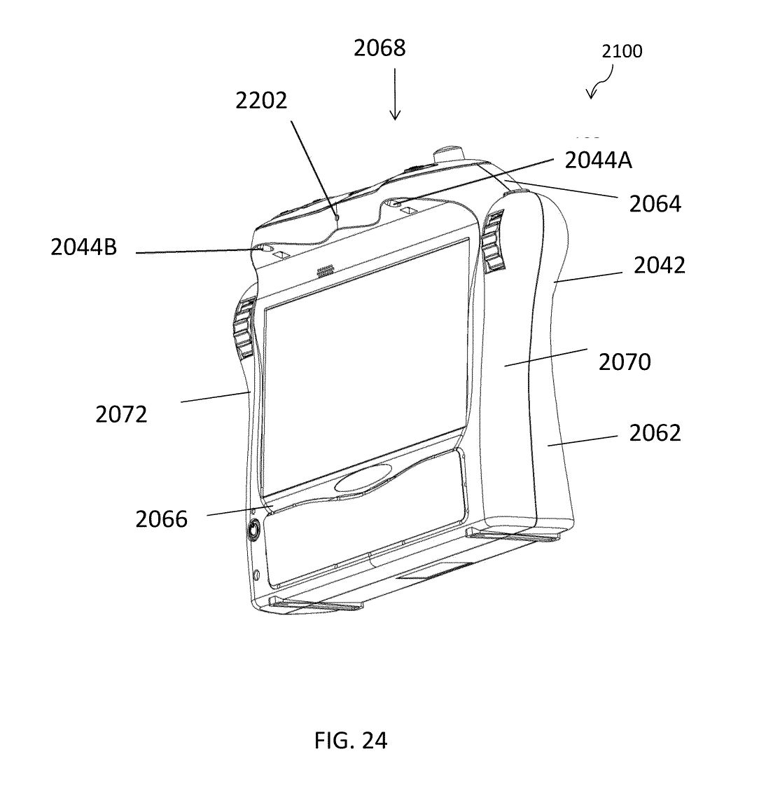

FIG. 24 discloses an alternate embodiment as disclosed in U.S. application Ser. No. 13/829,727 (hereafter '727 application”) filed on Mar. 14, 2013, which is incorporated herein by reference, as noted above. The assistive device 2100 of the '727 application includes a housing 2042. The housing 2042 may include a base region 2062 and a top region 2064 connected by a front wall 2066, back wall 2068, and two side walls 2070, 2072. The walls of the housing 2042 may be continuous and, together with the base region 2062 and the top region 2064, define an inner volume for accommodating therein electrical components (not shown) for carrying out functionalities of the vision assistive device 2100.

Still referring to FIG. 24, the vision assistive device 2100 can include a user-facing imaging unit 2202, which can be used for imaging the user for such purposes as video telephony. The user-facing imaging unit 2202 may be configured to be facing the user sitting in front of the vision assistive device 2100. It should of course be understood that the user-facing imaging unit 2202 can image any other object, for example, it can serve for surveillance. A switch may be provided to activate the user-facing imaging unit 2202, while deactivating other image capturing units 2044A, 2044B. The switch may inform the device control system which may then switch activity between the user-facing imaging unit 2202 and the other imaging units 2044A, 2044B, and optionally turns an indicator light on to let the user know which imaging unit camera is active, if any. In some embodiments, such a switch can alternatively be triggered by an accelerometer sensing the angle between the neck 2032 and the horizontal plane. Optionally, such a switch does not deactivate any imaging units, but rather selects which of the imaging units, if any, sends its image to be displayed to the user. Multiple switches can be used.

Still referring to FIG. 24, in operation, during normal video conference, the user-facing imaging unit may be used. However, when desired, the assistive device can be switched to the down-facing imaging units. For example if the user of the assistive device needs to show an object, such as a document or a pill bottle or a body part to the person on the other end of the line, the user can place that object it in front of the assistive device, and the person on the other end sees that object.

Still referring to FIG. 24, in some embodiments, the person on the other end can have control over the imaging unit in operation. In this manner, the person on the other end can simply instruct the user to place an object in front of the device, and switch the camera remotely.

In some embodiments, the down-facing imaging units may have a higher resolution then the forward-facing imaging units. The resolution can be controlled by the user or the person on the other end. The user or the person on the other end can switch to a maximum resolution, and see the full details of the object. Moreover, the person on the other end can get a still shot of the image of the down-facing camera.

Normally a lossy compression is used during video conference. If detailed high resolution picture is needed to be sent from one or more down facing cameras, the lossless compression can be used. Moreover, command to send uncompressed or compressed without loss high resolution image or images can be made by the person on the other end. Those images can be transferred using the same protocol as video conference of by a separate channel.

According to some aspects of the present disclosure, there is provided a system for simplifying operation of a computing device comprising a frame defining a receptacle, the receptacle being sized and shaped to receive a computing device; one or more controllers disposed on the frame; and an electrical connector disposed in the receptacle for electrically connecting the frame to the computing device, wherein when the frame is electrically connected to the computing device, the one or more controllers are enabled to operate the computing device.

According to some aspects of the present disclosure, there is provided a system for simplifying operation of a computing device comprising a frame defining a receptacle, the receptacle being sized and shaped to receive a computing device; one or more controllers disposed on the frame; an electrical connector disposed in the receptacle for electrically connecting the frame to the computing device; and a simplified user interface to be run on the computing device, wherein when the frame is electrically connected to the computing device, the one or more controllers of the frame are enabled to operate the computing device through the simplified user interface.

According to some aspects of the present disclosure, there is provided a method for simplifying a control of a computing device, the method comprising inserting a computing device into a receptacle defined by a frame, the frame further comprising one or more controllers disposed on the frame and an electrical connector disposed in the receptacle for electrically connecting the frame to the computing device; connecting the computing device to the frame through the electrical connector to enable the one or more controllers are enabled to operate the computing device; and using the one or more controllers of the frame to operate the computing device.

All patents, patent applications, and published references cited herein are hereby incorporated by reference in their entirety. It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the disclosure. It will be appreciated that several of the above-disclosed and other features and functions, or alternatives thereof, may be desirably combined into many other different systems or applications. All such modifications and variations are intended to be included herein within the scope of this disclosure, as fall within the scope of the appended claims.

What is claimed is:

1. A system for simplifying operation of a computing device comprising:
a frame defining a receptacle, the receptacle being sized and shaped to receive a computing device;
one or more controllers disposed on the frame; and
an electrical connector disposed in the receptacle for electrically connecting the frame to the computing device,
wherein when the frame is electrically connected to the computing device, the one or more controllers are enabled to operate the computing device.

2. The system of claim 1, wherein the receptacle is defined by a front wall and two side walls depending on the front wall of the frame.

3. The system of claim 1, wherein the receptacle is defined by a front wall, a back wall, two side walls connecting the front wall and the back wall of the frame.

4. The system of claim 1 further comprising multiple imaging units spaced apart from one another, wherein when the frame is electrically connected to the computing device, the one or more imaging units are in communication with the computing device.

5. The system of claim 5 wherein the multiple imaging units are arranged to capture an overlapping portions from a target image.

6. The system of claim 1 further comprising a stand comprising a base, one or more arms pivotably connected to the base at a first end and connected to the frame at a second end to provide support to the frame.

7. The system of claim 1 wherein the electrical connection between the frame and the computing device is wireless.

8. The system of claim 1, wherein the computing device is a tablet computer or a smart phone.

9. A system for simplifying operation of a computing device comprising:
a frame defining a receptacle, the receptacle being sized and shaped to receive a computing device;
one or more controllers disposed on the frame;
an electrical connector disposed in the receptacle for electrically connecting the frame to the computing device; and
a simplified user interface to be run on the computing device,
wherein when the frame is electrically connected to the computing device, the one or more controllers of the frame are enabled to operate the computing device through the simplified user interface.

10. The system of claim 9, wherein the receptacle is defined by a front wall and two side walls depending on the front wall of the frame.

11. The system of claim 9, wherein the receptacle is defined by a front wall, a back wall, two side walls connecting the front wall and the back wall of the frame.

12. The system of claim 9, wherein one or more imaging units are disposed on the frame, wherein when the frame is electrically connected to the computing device, the one or more imaging units are in communication with the computing device.

13. The system of claim 9 further comprising a stand comprising a base, one or more arms pivotably connected to the base at a first end and connected to the frame at a second end to provide support to the frame.

14. The system of claim 9 further comprising a switch between a native user interface of the tablet computer and the simplified user interface.

15. A method for simplifying a control of a computing device:
inserting a computing device into a receptacle defined by a frame, the frame further comprising one or more controllers disposed on the frame and an electrical connector disposed in the receptacle for electrically connecting the frame to the computing device;
connecting the computing device to the frame through the electrical connector to enable the one or more controllers are enabled to operate the computing device; and
using the one or more controllers of the frame to operate the computing device.

16. The method of claim 15 further comprising:
switching from a native user interface of the computing device to a simplified interface; and
operating the computing device with the one or more controllers of the frame through the simplified user interface.

17. The method of claim 15, wherein the frame further comprises multiple imaging units spaced apart from one another.

18. The method of claim 15 further comprising capturing an image from a target with one or more imaging units disposed on the frame and displaying image on a screen of the computing device.

19. The method of claim 15 further comprising supporting the frame by a stand, the stand comprising a base, one or more arms pivotably connected to the base at a first end and connected to the frame at a second end to provide support to the frame.

20. The method of claim 15 wherein the computing device is a tablet computer or a smart phone.
